(19) United States
(12) Patent Application Publication
(10) Pub. No.: US 2024/0374347 A1
(43) Pub. Date: Nov. 14, 2024

(54) CORRECTING RELATIVE TOOTH POSITIONS OF ANTAGONISTIC TEETH

(71) Applicant: EXOCAD GMBH, Darmstadt (DE)

(72) Inventors: Clemens SCHWERIN, Riedstadt (DE); Julian FREISE, Munich (DE)

(21) Appl. No.: 18/196,745

(22) Filed: May 12, 2023

(51) Int. Cl. A61C 7/00; A61C 9/00; A61C 13/34; A61C 19/05; G06T 17/00; G06T 19/20

(52) U.S. Cl. CPC A61C 7/002; A61C 9/0053; A61C 13/34; A61C 19/05; G06T 17/00; G06T 19/20; A61C 2007/004; G06T 2210/41; G06T 2219/2004

(57) ABSTRACT

Disclosed is a method for correcting relative tooth positions of antagonistic teeth in occlusion for matching a natural occlusion. A three-dimensional digital maxillary teeth model of a first set of teeth comprising first markings and a three-dimensional digital mandibular teeth model of a second set of teeth comprising second markings are received. First and second surface contact sections are identified using the first and second markings. The identified first and second surface contact sections are paired. The three-dimensional digital maxillary teeth model and the three-dimensional digital mandibular teeth model are arranged in occlusion. For one or more pairs of antagonistic teeth positions of the antagonistic teeth are corrected. The correcting comprises establishing contacts between the first surface contact sections and second surface contact sections of the antagonistic teeth.

### FIELD OF THE INVENTION

The invention relates to the field of dental technology. More particularly, the invention relates to a computer-implemented method for correcting relative tooth positions of antagonistic teeth in occlusion for matching a natural occlusion. The invention furthermore relates to a computer program product and a system for correcting relative tooth positions of antagonistic teeth in occlusion for matching a natural occlusion.

### BACKGROUND

In modern dental technology, computer-based approaches are used for determining measures to be applied to a patient's dentition. For example, dental restoration elements, like crown or bridges, are configured. However, in order to be able to precisely determine such measures it may have to be ensured that these measures comply with the patient's occlusion. For checking the occlusion, antagonistic teeth provided in form of three-dimensional digital models of the patient's maxillary and mandible may have to be positioned relative to each other in positions matching precisely the patient's natural occlusion. Matching precisely a patient's natural occlusion with three-dimensional digital models of the patient's maxillary and mandible may be a challenging task.

It is an objective to provide for a method, a computer program product and a system for correcting relative tooth positions of antagonistic teeth in occlusion for matching a natural occlusion. The objectives underlying the invention are solved by the features of the independent claims.

### SUMMARY

In one aspect, the invention relates to a computer-implemented method for correcting relative tooth positions of antagonistic teeth in occlusion for matching a natural occlusion. The method comprises receiving a three-dimensional digital maxillary teeth model of a first set of one or more teeth of a maxilla of a patient. The teeth of the first set of teeth comprise first markings identifying one or more first surface contact sections of the teeth. In natural occlusion, the one or more first surface contact sections are in contact with one or more second surface contact sections of one or more antagonistic teeth of a mandible of the patient. A three-dimensional digital mandibular teeth model of a second set of one or more teeth of the mandible of the patient is received. The teeth of the second set of teeth comprise one or more second markings identifying one or more of the second surface contact sections of the teeth. The first and second surface contact sections comprised by the teeth of the first and second set teeth are identified using the first and second markings. The identified first and second surface contact sections are paired. The pairing comprises determining pairs of first and second surface contact sections contacting each other in natural occlusion. The three-dimensional digital maxillary teeth model and the three-dimensional digital mandibular teeth model are arranged in occlusion. For one or more pairs of antagonistic teeth comprised by the first and second set of teeth relative tooth positions of the antagonistic teeth of the individual pairs are corrected. The correcting of the relative tooth positions comprises establishing contacts between the first surface contact sections and second surface contact sections of the pairs of first and second surface contact sections comprised by the antagonistic teeth of the individual pairs of antagonistic teeth.

For generating a three-dimensional digital model of a patient's dentition provided in form of a maxillary teeth model and three-dimensional digital mandibular teeth model a scan of the patient's detention, in particular an intraoral scan of the patient's detention may be used. In order to be able to scan the full teeth, i.e., also occlusal and oral surfaces of the teeth, scan data of the teeth is acquired, while the patient's mouth is open. In this case, the patient's teeth are not in occlusion during data acquisition. However, the teeth arranged within the alveolar bone are held in place by tissue fibers resulting in a certain degree flexibility. When occlusion is established, e.g., during chewing or at rest, a certain degree of compressive forces acts upon the teeth resulting in a slight shift of individual teeth positions relative the alveolar bone and/or the gingiva will occur. Therefore, relative positions of teeth within the maxillary dental arch and/or of teeth within the mandibular dental arch may differ in occlusion from the relative positions, when the scan data is acquired.

Teeth are attached to the alveolar bone, within which they sit, by the periodontal ligament (PDL). The PDL is a group of specialized connective tissue fibers that essentially attach a tooth to the alveolar bone. These tissue fibers comprise principal fibers, loose connective tissue, blast and clast cells, oxytalan fibers and Cell Rest of Malassez. On one side the PDL inserts into root cementum of the respective tooth and on the other side onto the alveolar bone. The PDL is a part of the periodontium, i.e., specialized tissues that both surround and support the teeth, maintaining them in the maxillary and mandibular bones. The periodontium comprises the gingiva, PDL, cementum and alveolar bone proper. PDL fibers also provide a role in load transfer between the teeth and alveolar bone by absorbing and transmitting forces between teeth and alveolar bone. Thereby, the PDL helps the tooth to withstand compressive forces that occur during chewing and remain embedded in the bone. The ends of the principal fibers arranged within the cementum or alveolar bone proper are considered Sharpey fibers.

Intraoral scanners may be used for automatically capturing size and shape of teeth within a patient's oral cavity. The resulting intraoral scan resembles a digital impression of the patient's mouth. Dental arches inside a patient's mouth are scanned, e.g., using a small camera, and recorded as digital data. This digital data is used to provide three-dimensional digital models of the teeth within the patient's mouth. Each dental arch, i.e., mandibular, and maxillary arch, may be scanned on its own.

There are further factors, which may also contribute to deviations of relative tooth positions caused by the occlusion. For example, the mandibular jawbone has a certain degree of flexibility, which may contribute to the deviation, in case the mandibular jawbone slightly deforms under occlusal pressure.

Examples may have the beneficial effect that deviations of relative tooth positions caused by the occlusion may be effectively be taken into account enabling a precise matching of a patient's natural occlusion, i.e., the teeth may be arranged in positions relative to each other and/or the gingiva, which are identical to the positions acquired by the teeth in natural occlusion.

The received three-dimensional digital maxillary teeth model is, e.g., generated using scan data acquired by an intraoral scan of the patient's maxillary dental arch. Each of these teeth may be provided in form of an individual three-dimensional digital tooth model comprised by the three-dimensional digital maxillary teeth model. The three-dimensional digital maxillary teeth model is indicative of relative positions of the teeth of the first set of one or more teeth of the maxilla of the patient. Furthermore, the three-dimensional digital maxillary teeth model may comprise a three-dimensional digital maxillary gingiva model of the patient's maxillary gingiva. In this case, the three-dimensional digital maxillary teeth model may also be indicative of positions of the teeth of the first set of one or more teeth relative to the three-dimensional digital maxillary gingiva model, i.e., the patient's gingiva. For example, intraoral scan data of the patient's maxillary may be acquired and the three-dimensional digital maxillary teeth model generated using this scan data. For providing individual three-dimensional digital tooth models and/or a three-dimensional digital maxillary gingiva model, the three-dimensional digital maxillary teeth model generated using this scan data may be segmented.

The received three-dimensional digital mandibular teeth model is, e.g., generated using scan data acquired by an intraoral scan of the patient's mandibular dental arch. Each of these teeth may be provided in form of an individual three-dimensional digital tooth model comprised by the three-dimensional digital mandibular teeth model. The three-dimensional digital mandibular teeth model is indicative of relative positions of the teeth of the second set of one or more teeth of the maxilla of the patient. Furthermore, the three-dimensional digital mandibular teeth model may comprise a three-dimensional digital mandibular gingiva model of the patient's mandibular gingiva. In this case, the three-dimensional digital mandibular teeth model may also be indicative of positions of the teeth of the second set of one or more teeth relative to the three-dimensional digital mandibular gingiva model, i.e., the patient's gingiva. For example, intraoral scan data of the patient's mandible may be acquired and the three-dimensional digital mandibular teeth model generated using this scan data. For providing individual three-dimensional digital tooth models and/or a three-dimensional digital mandibular gingiva model, the three-dimensional digital mandibular teeth model generated using this scan data may be segmented.

The three-dimensional digital maxillary teeth model may be a three-dimensional digital model of a current state of the patient's maxillary dental arch. This three-dimensional digital maxillary teeth model as a current state model of the respective maxillary dental arch may resemble an actual state of the patient's maxillary dental arch, i.e., it may be a digital replica of the physical maxillary dental arch. The three-dimensional digital maxillary teeth model may, e.g., be generated by a computer system executing the method for correcting relative tooth positions of antagonistic teeth in occlusion for matching a natural occlusion or it may be received from an external source. The external source may, e.g., be a server, like a cloud server, providing the three-dimensional digital maxillary teeth model via a network. The external source may, e.g., be a removable storage device providing the three-dimensional digital maxillary teeth model via a direct communication connection, e.g., wireless or via a wire.

The three-dimensional digital mandibular teeth model may be a three-dimensional digital model of a current state of the patient's mandibular dental arch. This three-dimensional digital mandibular teeth model as a current state model of the respective mandibular dental arch may resemble an actual state of the patient's mandibular dental arch, i.e., it may be a digital replica of the physical mandibular dental arch. The three-dimensional digital mandibular teeth model may, e.g., be generated by a computer system executing the method for correcting relative tooth positions of antagonistic teeth in occlusion for matching a natural occlusion or it may be received from an external source. The external source may, e.g., be a server, like a cloud server, providing the three-dimensional digital mandibular teeth model via a network. The external source May e.g., be a removable storage device providing the three-dimensional digital mandibular teeth model via a direct communication connection, e.g., wireless or via a wire.

The teeth of the first set of teeth comprise first markings identifying one or more first surface contact sections of the teeth, which in in natural occlusion are in contact with one or more second surface contact sections of the antagonistic teeth of the mandible provided by the second set of teeth. The teeth of the second set of teeth comprise second markings identifying the second surface contact sections. By the first and second marking contact sections are identified, at which antagonistic teeth are in contact in case natural occlusion is established. Thus, by arranging the teeth of the three-dimensional digital maxillary teeth model and the three-dimensional digital mandibular teeth model in relative positions, such that contacts between antagonistic teeth are established at the identified contact sections, the natural occlusion may be matched precisely.

The first and second markings may, e.g., be generated on the surface of the patient's teeth prior to the acquisition of scan data using articulating paper, on which the patient bites. When the patient bites onto the articulating paper, the natural occlusion may be assumed by the teeth. Where the teeth get in contact with the articulating paper, they may be marked using a marking color comprised by the articulating paper. The scan data of the intraoral scan may be indicative of the resulting first and second markings. Thus, when generating the three-dimensional digital mandibular teeth model and the three-dimensional digital maxillary teeth model using the acquired scan data, the generated models may comprise the first and second markings, e.g., be indicative of the contact sections.

Articulating paper, also referred to as occlusion paper, is a tool used in dentistry to highlight occlusal contacts. That is, it marks those surface sections on the teeth, where the teeth contact during biting. Articulating paper is, e.g., made of a thin, non-adhesive paper strip covered in ink, e.g., fluorescent ink, or dye-containing wax. A strip of articulating paper is placed between the teeth while the desired mandibular movements are performed. For example, the articulating paper is placed on the occlusal surface of the teeth and the patient asked to bite onto the articulating paper, which will mark the occlusal contacts between the teeth of the mandibular and maxillary jaws of the patient.

In order to match the patient's natural occlusion with the teeth comprised by the three-dimensional digital mandibular teeth model and the three-dimensional digital maxillary teeth model, the first and second surface contact sections marked by the first and second markings are identified. The identified first and second surface contact sections are paired, i.e., it is identified which of the first surface contact sections contacts which of the second surface contact sections. This identification may, e.g., be executed using the forms of the markings and/or the positions of the markings. The positions of the markings may, e.g., be indicative of the tooth on which the respective marking is arranged and/or of the position on an occlusal surface of the respective tooth. For the pairing, it may, e.g., be assumed that only contact sections of antagonistic teeth are in contact with each other in natural occlusion. Thus, for antagonistic teeth, it may be determined which contact section match each other in form and/or position on the occlusal surfaces of the respective antagonist teeth. Thereby, pairs of the first and second surface contact sections contacting each other in natural occlusion may be identified and, e.g., assigned to each other.

Then, the three-dimensional digital maxillary teeth model and the three-dimensional digital mandibular teeth model may be arranged in occlusion, i.e., in a preliminary occlusion.

For example, additional scan data of the patient's dentition in occlusion may be acquired. The additional scan data may, e.g., be indicative of a relative position of one or more teeth of the first set of teeth comprised by the three-dimensional digital maxillary teeth model relative to one or more teeth of the second set of teeth comprised by the three-dimensional digital mandibular teeth model. Thus, the additional scan data may be used for arranging the three-dimensional digital maxillary teeth model relative to the three-dimensional digital mandibular teeth model in a relative position, such that the respective teeth of the first set of teeth comprised by the three-dimensional digital maxillary teeth model are arranged in the relative position relative to the teeth of the second set of teeth comprised by the three-dimensional digital mandibular teeth model as indicated by the addition scan data. Since the relative position of the teeth of the three-dimensional digital mandibular teeth model and the teeth of three-dimensional digital maxillary teeth model is a position in three dimensions, while the additional scan data scanning the teeth in occlusion from a vestibular direction may only provide two-dimensional information. Thus, the position information regarding the occlusion may only be preliminary, while the precise position in three-dimensional space may be determined using the first and second markings.

For example, additional scan data of the patient's dentition in occlusion may be acquired. The additional scan data may, e.g., be indicative of a relative position of a three-dimensional digital maxillary gingiva model comprised by the three-dimensional digital maxillary teeth model relative to a three-dimensional digital mandibular gingiva model comprised by the three-dimensional digital mandibular teeth model. Thus, the additional scan data may be used for arranging the three-dimensional digital maxillary teeth model relative to the three-dimensional digital mandibular teeth model in a relative position, such that the three-dimensional digital maxillary gingiva model comprised by the three-dimensional digital maxillary teeth model is arranged in the relative position relative to the three-dimensional digital mandibular gingiva model comprised by the three-dimensional digital mandibular teeth model as indicated by the addition scan data.

For one or more pairs of antagonistic teeth comprised by the first and second set of teeth relative tooth positions of the antagonistic teeth of the individual pairs are corrected. The relative tooth positions may be corrected such that contacts between the first surface contact sections and second surface contact sections of the pairs of first and second surface of the respective antagonistic teeth of the individual pairs are established. For example, the relative tooth positions may be corrected such that contacts between antagonistic teeth are established only by the first and second contact sections.

By establishing the contacts and/or ensuring the contacts between the first and second contact sections, it may be ensured that the teeth of the three-dimensional digital mandibular teeth model and three-dimensional digital maxillary teeth model are arranged in relative positions to each other precisely matching the relative positions of mandibular and maxillary teeth in natural occlusion.

For example, corresponding teeth of different pairs may be moved by the same amount. For example, the relative positions of antagonistic teeth of all pairs of antagonistic teeth may be corrected the same way. For example, corresponding teeth of different pairs may be moved by different amount. For example, the relative positions of antagonistic teeth of different pairs of antagonistic teeth may be corrected in different way individually ensuring correct contacts between first and second contact sections.

For example, the correcting of the tooth positions comprises moving the antagonistic teeth in opposite directions along tooth axes of the respective teeth. By moving antagonistic teeth in opposite directions along tooth axes, contacts between first and second contact sections of the respective antagonistic teeth may be established. Depending on the relative position of the antagonistic teeth relative to each other, the antagonistic teeth may be moved towards each other or away from each other along the tooth axes of the respective teeth.

For example, the antagonistic teeth of one or more first pairs of the pairs of antagonistic teeth interpenetrate each other. The correcting of the tooth positions comprises moving the antagonistic teeth of the individual first pairs apart from each other along the tooth axes of the respective teeth, until one or more contacts between the one or more pairs of first and second surface contact sections comprised by the respective antagonistic teeth are established. By moving the antagonistic teeth of the individual first pairs apart from each other along the tooth axes of the respective teeth, the interpenetrate may be resolved and the contacts between first and second contact sections of the respective antagonistic teeth may be established.

For example, the antagonistic teeth of one or more second pairs of the pairs of antagonistic teeth comprise pairs of first and second surface contact sections arranged spaced apart from each other. The correcting of the tooth positions comprises moving the antagonistic teeth of the individual second pairs towards each other along the tooth axes of the respective teeth, until one or more contacts between the one or more pairs of first and second surface contact sections comprised by the respective antagonistic teeth are established. By moving the antagonistic teeth of the individual second pairs towards each other along the tooth axes of the respective teeth the contacts between first and second contact sections of the respective antagonistic teeth may be established.

For example, the antagonistic teeth of the individual are moved by the same amount. For example, antagonistic teeth of the individual are moved by the different amounts.

For example, for each pair of antagonist teeth the correcting of the tooth positions may comprise a moving of both teeth. Thus, teeth of the first set of teeth and teeth of the second set of teeth may be moved, in order to establish the contacts between first and second contact sections of antagonistic teeth.

For example, the correcting of the tooth positions comprises moving only teeth of one of the following: the first set of teeth, the second set of teeth. For example, only teeth of the first set of teeth may be moved, in order to establish the contacts between first and second contact sections of antagonistic teeth. For example, only teeth of the second set of teeth may be moved, in order to establish the contacts between first and second contact sections of antagonistic teeth.

For example, in case of the first pairs of antagonistic teeth, i.e., of antagonistic teeth interpenetrating each other, the correcting of the tooth positions comprises a moving of the teeth to be moved along the tooth axes of the respective teeth away from the teeth not to be moved along the tooth axes of the respective teeth, until the one or more contacts between the one or more pairs of first and second surface contact sections of the respective antagonistic teeth are established.

For example, in case of the second pairs of antagonistic teeth, i.e., of antagonistic teeth comprising pairs of first and second surface contact sections arranged spaced apart from each other, the correcting of the tooth positions comprises a moving of the teeth to be moved along the tooth axes of the respective teeth towards the teeth not to be moved along the tooth axes of the respective teeth, until the one or more contacts between the one or more pairs of first and second surface contact sections of the respective antagonistic teeth are established.

For example, the correcting of the tooth positions further comprises moving teeth of the pairs of antagonistic teeth perpendicular to the tooth axes of the respective teeth. Thus, the position of the respective teeth may be adjusted in second and/or third directions perpendicular to the tooth axes defining first directions. The second and third directions may extend perpendicular to each other. Moving the teeth along the tooth axes may result in a one-dimensional adjustment of the positions of the teeth. Moving teeth of the pairs of antagonistic teeth perpendicular to the tooth axes of the respective teeth may result in a two-dimensional or three-dimensional adjustment of the positions of the teeth.

For example, the correcting of the tooth positions further comprises rotating teeth of the pairs of antagonistic teeth around one or more axes of rotation of the respective teeth. Thus, also rotations of the teeth may be used for establishing the contacts of the first and second contact sections.

For example, the one or more axes of rotation comprise one or more of the following axes per tooth extending perpendicular to each other: the tooth axis of the respective tooth, an axis extending in vestibula direction of the respective tooth, an axis extending in mesial direction of the respective tooth. A tooth to be adjusted may be rotated the tooth axis of the respective tooth, an axis extending in vestibula direction of the respective tooth, and/or an axis extending in mesial direction of the respective tooth. Thus, rotations for establishing the contacts of the first and second contact sections may effectively be implemented in three dimension as necessary.

For example, in case a number of pairs of first and second surface contact sections exceeds a number of interpenetrations between the teeth of the first and second sets of teeth in occlusion by a predefined first amount, an error message is output and one or more of the following is repeated: the identifying, the pairing. For example, compressive forces occurring in occlusion may result in a slight movement of the teeth into the alveolar bone, in which they are arranged. Neglecting this movement, when arranging the three-dimensional digital mandibular teeth model and the three-dimensional digital mandibular teeth model in preliminary occlusion, it may be expected that interpenetrations may occur for all or at least most of the pairs of first and second contact section. Thus, the number of pairs exceeding the number of interpenetrations may be indicative of a potential error, which occurred during the identifying and/or pairing. By repeating the identifying and/or the pairing such potential errors may be resolved.

The first amount, e.g., being one of the following: one, two, three, four five, six, seven, eight, nine, ten. The first amount, e.g., being defined as one of the following: 1% of the number of interpenetrations, 2% of the number of interpenetrations, 3% of the number of interpenetrations, 4% of the number of interpenetrations, 5% of the number of interpenetrations, 6% of the number of interpenetrations, 7% of the number of interpenetrations, 8% of the number of interpenetrations, 9% of the number of interpenetrations, 10% of the number of interpenetrations.

For example, the method further comprises acquiring first scan data of the first set of teeth of the maxilla of the patient using an intraoral scanner. The first sections of the teeth are marked with the first markings. Second scan data of the second set of teeth of the mandible of the patient is acquired using the intraoral scanner. The second sections of the teeth are marked with the second markings. Using the first scan data the three-dimensional digital maxillary teeth model is generated comprising the first markings. Using the second scan data the three-dimensional digital mandibular teeth model is generated comprising the second markings.

The receiving of the three-dimensional digital mandibular teeth model and the three-dimensional digital maxillary teeth model may, e.g., comprise the generating of the three-dimensional digital mandibular teeth model and the three-dimensional digital maxillary teeth model. For generating the three-dimensional digital mandibular teeth model and the three-dimensional digital maxillary teeth model, first scan data of the first set of teeth of the maxilla and second scan data of the second set of teeth of the mandible may be used. For example, the receiving of the three-dimensional digital mandibular teeth model and the three-dimensional digital maxillary teeth model may, e.g., also comprise the acquiring to the first and second scan data, e.g., using an intraoral scanner.

For example, in case the number of interpenetrations between the teeth of the first and second sets of teeth in occlusion exceeds the number of pairs of first and second surface contact sections determined by a predefined second amount, an error message is output and the acquiring of the first and second scan data as well as the generating of the three-dimensional digital maxillary teeth model and the three-dimensional digital mandibular teeth model is repeated.

The second amount, e.g., being one of the following: one, two, three, four five, six, seven, eight, nine, ten. The second amount, e.g., being defined as one of the following: 1% of the number of interpenetrations, 2% of the number of interpenetrations, 3% of the number of interpenetrations, 4% of the number of interpenetrations, 5% of the number of interpenetrations, 6% of the number of interpenetrations, 7% of the number of interpenetrations, 8% of the number of interpenetrations, 9% of the number of interpenetrations, 10% of the number of interpenetrations

For example, compressive forces occurring in occlusion may result in a slight movement of the teeth into the alveolar bone, in which they are arranged. Neglecting this movement, when arranging the three-dimensional digital mandibular teeth model and the three-dimensional digital mandibular teeth model in preliminary occlusion, it may be expected that interpenetrations may occur for all or at least most of the pairs of first and second contact section. Thus, the number of interpenetrations exceeding the number of pairs may be indicative of a potential error of identifying contact sections by markings. For example, when acquiring scan data of the patient's mandibular and maxillary dental arch, errors regarding the acquisition of scan data indicative of the first and/or second markings may have occurred. By repeating the acquiring of the first and second scan data as well as the generating of the three-dimensional digital maxillary teeth model and the three-dimensional digital mandibular teeth model such potential errors may be resolved.

For example, the method further comprises segmenting the teeth of the three-dimensional digital maxillary teeth model and the three-dimensional digital mandibular teeth model. The segmenting of the teeth may enable a movement of individual teeth independent of each other. Furthermore, the segmenting of the teeth may result in a definition of a three-dimensional digital mandibular gingiva model, e.g., as the residual rest of the three-dimensional digital mandibular teeth model remaining after the segmenting of the mandibular teeth. Furthermore, the segmenting of the teeth may result in a definition of a three-dimensional digital maxillary gingiva model, e.g., as the residual rest of the three-dimensional digital maxillary teeth model remaining after the segmenting of the maxillary teeth.

For example, the method further comprises acquiring occlusion scan data of the first set of teeth, which are in occlusion with the second set of teeth, using the intraoral scanner. The occlusion scan data is used for the arranging of the three-dimensional digital maxillary teeth model and the three-dimensional digital mandibular teeth model in occlusion. Using the occlusion scan data, information regarding a preliminary occlusion of the three-dimensional digital maxillary teeth model and the three-dimensional digital mandibular teeth model may be provided.

For example, the method further comprises marking the first sections of the first set of teeth with the first markings for the acquiring of the first scan data and marking the second surface contact sections of the second set of teeth with the second markings for the acquiring of the first scan data using articulating paper, on which the patient bites.

When the patient bites onto the articulating paper, the natural occlusion may be assumed by the teeth. Where the teeth get in contact with the articulating paper, they may be marked using a marking color comprised by the articulating paper. The scan data of the intraoral scan may be indicative of the resulting first and second markings. Thus, when generating the three-dimensional digital mandibular teeth model and the three-dimensional digital maxillary teeth model using the acquired scan data, the generated models may comprise the first and second markings, e.g., be indicative of the contact sections.

For example, the first and second surface contact sections are marked using a visible marking color detectable by the intraoral scanner. For example, the first and second surface contact sections are marked using an invisible marking color detectable by the intraoral scanner and represented using a visible color for the first markings in the three-dimensional digital maxillary teeth model and for the second markings in the mandibular teeth model.

For example, the three-dimensional digital maxillary teeth model comprises a maxillary dental arch of the patient. For example, the three-dimensional digital mandibular teeth model comprises a mandibular dental arch of the patient.

For example, the method further comprises generating a three-dimensional digital dental restoration model defining a form of the dental restoration element to be used for restoring one or more of the teeth of the three-dimensional digital maxillary teeth model or the three-dimensional digital mandibular teeth model.

The three-dimensional digital restoration model may, e.g., define a form of a dental restoration element to be provided for restoring one or more of the teeth of the three-dimensional digital maxillary teeth model or the three-dimensional digital mandibular teeth model. For receiving the dental restoration element defined by the respective three-dimensional digital restoration model, the respective tooth may have to be prepared. The three-dimensional digital restoration model may be constructed such that it complies with the restriction regarding its extension in occlusal direction defined by the corrected relative position of the teeth in natural occlusion. The three-dimensional digital restoration model may, e.g., be generated by a computer system executing the method for correcting relative tooth positions of antagonistic teeth in occlusion for matching a natural occlusion.

For generating the three-dimensional digital restoration model, e.g., a three-dimensional digital library tooth model from a digital tooth library may be used. For example, the three-dimensional digital library tooth model may in addition be adjusted to the dentition of the patient. For example, a three-dimensional digital tooth model of another tooth of the patient's dentition, e.g., an opposite tooth within the same dental arch or an antagonist, may be used for generating the three-dimensional digital restoration model. For example, the three-dimensional digital tooth model of the other tooth may in addition be adjusted to the dentition of the patient. For example, the three-dimensional digital restoration model may be generated from scratch.

For example, the method further comprises controlling a manufacturing device for manufacturing the dental restoration element in form of a physical copy of the three-dimensional digital dental restoration model.

For manufacturing the dental restoration element, e.g., computer-controlled additive and/subtractive methods may be used. For example, the dental restoration element may be manufactured using one of the following: machining, 3D printing, casting.

Examples may have the beneficial effect, that the dental restoration element may be manufactured using a machining device configured to manufacture the dental restoration element by processing a blank of restoration material. For example, the dental restoration element may be manufactured using a 3D printing device, i.e., a printer, configured to print the dental restoration element.

For example, the dental restoration element is one of the following: a veneer, a coping with coating, an inlay, an onlay, an overlay, a crown, a bridge, a mockup, a waxup, a provisional.

A veneer is a layer of restoration material placed over a tooth, in order to cover one or more surfaces of the tooth. Veneers may, e.g., improve the aesthetics of a smile and/or protect the tooth's surface from damage. Indirect veneers are manufactured outside of a patient's oral cavity and then arranged on a tooth within the oral cavity. Direct veneers are built-up directly on a tooth inside a patient's oral cavity. The tooth may be prepared for receiving the veneer.

For example, two main types of restoration material may be used for manufacturing a veneer: composite and dental porcelain. A composite veneer may be directly placed on the tooth, i.e., built-up in the mouth of patient, or indirectly manufactured outside the mouth of the patient and later bonded to the tooth. In contrast, a porcelain veneer may only be indirectly manufactured outside the mouth of the patient. A full veneer crown, on the one hand, is dental restoration element that is configured to cover all the coronal tooth surfaces, i.e., the mesial, distal, facial, lingual and occlusal surfaces. A laminate veneer, on the other hand, is a thin layer of restoration material that may, e.g., cover only a single surface of a tooth, e.g., a labial surface. A laminate veneer may generally be used for aesthetic purposes.

Coping with coating refers to a dental restoration element, which is directly built on the tooth to be restored. An underlying coping is arranged on the tooth. The coping is configured to replicate the performance of a natural tooth. On the coping a coating is applied, which is configured to replicate the natural aesthetics of the tooth to be restored. For example, a ceramic coating may be used. Using a coping with coating to restore a tooth may have the beneficial effect of providing a dental restoration element that combines both durability and natural aesthetics.

Inlays, onlays, and overlays are forms of indirect restoration manufactured outside of a patient's oral cavity as a single, solid piece that fits a specific size and shape of a reception prepared within a tooth of the oral cavity. The inlay, onlay, or overlay is arranged within the respective reception and bonded, e.g., cemented, in place on the prepared tooth. In contrary to a crown, inlays, onlays, and overlays are arranged within a reception prepared within a damaged tooth.

An inlay is configured to cover an inner, e.g., central, section of an occlusal surface of a tooth. Thus, an inlay may be used to replace an internal part of a damaged tooth and cover part of the occlusal surface of the respective tooth. The inlay is positioned within hard tissues of the tooth, but does not cover a cusp or pointed part of the tooth. In comparison to an inlay, an onlay in addition covers at least one of the cusps of the tooth. In comparison to an onlay, an overlay covers a larger portion of the occlusal surface of the tooth extending beyond the cusps.

The inlays, onlays, and overlays may, e.g., be configured as pinlays. Pinlays are characterized by an additional use of pins to increase their retention. Thus, any inlay, onlay, or overlay may be configured as a pinlay by being braced by pins. Such a pin may, e.g., be inserted at an edge of the tooth or parallel to a groove. In general, the base of a pin is selected to lie in a section of the tooth surface that is free of damage.

A crown is a dental restoration element in form of a dental cap. Such a crown may, e.g., be provided in form of a full coverage crown or a partial crown, like a ⅞ crown or a ¾ crown. Partial crowns, like ⅞ and ¾ crowns, are hybrids between an onlay and a full coverage crown. They are categorized based on an estimated degree of wall coverage of the walls of the prepared tooth, on which the respective crown is arranged. For example, a ¾ crown aims to cover three thirds of the walls of the tooth to be restored, e.g., three out of the four walls, e.g., with the buccal wall being spared. For example, a ⅞ crown aims to cover seven eights of the walls of the tooth to be restored. A full coverage crown completely caps or encircles a prepared tooth. A crown may, e.g., be required when a large cavity threatens the health of a tooth. A crown may be bonded to the tooth prepared for receiving the crown using a bonding material, e.g., a dental cement. A crown may be made from various materials, which may be fabricated using indirect methods, i.e., outside the patient's oral cavity. Crowns may be used to improve strength, to improve appearance of teeth and/or to halt deterioration.

A bridge is a dental restoration element in form of a permanent appliance used to replace one or more missing teeth. A dental bridge comprises a plurality of artificial dental elements that are fused together, e.g., one or more artificial replacement teeth are definitively joined to adjacent teeth. A conventional bridge may be supported, e.g., by full coverage crowns, partial crowns, overlays, onlays or inlays on the abutment teeth. The abutment teeth require preparation and reduction to support the bridge.

A mockup prosthetic restoration composite is a composite to be arranged within a patient's mouth in order to visualize for the patient a result of a prosthetic restoration, before the actual prosthetic restoration is executed. Thus, the patient as well as a dentist may assess the expected esthetic and functional outcome of the prosthetic restoration. The final result to be expected may thus be visualized at an early stage of planning a prosthetic restoration. This approach may ensure that the patient as well as the dentist may the same result to be achieved in mind and allows for potential adjustments to be made prior to the final restorations manufactured and applied, e.g., cemented.

A waxup prosthetic restoration refers to a prosthetic restoration made from laboratory wax. Such a waxup prosthetic restoration is used for acquiring information indicative of whether a specific prosthetic restoration is appropriate. A planned prosthetic restoration may be generated using from laboratory wax. The waxup prosthetic restoration may be used to test, whether the planned prosthetic restoration is appropriate. Using wax may have the beneficial effect, that the waxup prosthetic restoration may be easily adjusted to also test adjustments of the planned prosthetic restoration and/or adjusting the planned prosthetic restoration to requirements determined using the waxup prosthetic restoration.

A waxup model may, e.g., be used by a doctor and/or a practitioner for visualization purposes. Furthermore, it may, e.g., also be used for generating one or more in-mouth preparation guiding surfaces, e.g., using silicon imprints, where the doctor and/or practitioner may measure and/or visually gauge, whether a planned tooth reduction has been performed.

A provisional is a type of interim dental restoration designed to be a template for the final restoration. It is used to verify, e.g., a comfort in occlusion for the patient, esthetic parameters that satisfy the patient's and dentist's expected goals and/or phonetic evaluation for speech and airflow. Esthetic parameters ma, e.g., comprise shape, midlines, smile line, embrasure shapes, and/or position of contacts. The phonetic evaluation for speech and airflow may ensure that no sibilance, whistlers, and/or lisp occur and a clear articulation being enabled by the prosthetic restoration resembled by the provisional.

In another aspect, the invention relates to a computer program product for correcting relative tooth positions of antagonistic teeth in occlusion for matching a natural occlusion. The computer program product comprises a computer readable storage medium having program instructions embodied therewith. The program instructions are executable by a processor of a computer device to cause the computer device to receive a three-dimensional digital maxillary teeth model of a first set of one or more teeth of a maxilla of a patient. The teeth of the first set of teeth comprise first markings identifying one or more first surface contact sections of the teeth. In natural occlusion, the one or more first surface contact sections are in contact with one or more second surface contact sections of one or more antagonistic teeth of a mandible of the patient. A three-dimensional digital mandibular teeth model of a second set of one or more teeth of the mandible of the patient is received. The teeth of the second set of teeth comprise one or more second markings identifying one or more of the second surface contact sections of the teeth. The first and second surface contact sections comprised by the teeth of the first and second set teeth are identified using the first and second markings. The identified first and second surface contact sections are paired. The pairing comprises determining pairs of first and second surface contact sections contacting each other in natural occlusion. The three-dimensional digital maxillary teeth model and the three-dimensional digital mandibular teeth model are arranged in occlusion. For one or more pairs of antagonistic teeth comprised by the first and second set of teeth relative tooth positions of the antagonistic teeth of the individual pairs are corrected. The correcting of the relative tooth positions comprises establishing contacts between the first surface contact sections and second surface contact sections of the pairs of first and second surface contact sections comprised by the antagonistic teeth of the individual pairs of antagonistic teeth.

The program instructions provided by the computer program product may further be executable by the processor of the computer device to cause the computer device to execute any of the aforementioned examples of the method for correcting relative tooth positions of antagonistic teeth in occlusion for matching a natural occlusion.

In another aspect, the invention relates to a computer program for correcting relative tooth positions of antagonistic teeth in occlusion for matching a natural occlusion. The computer program comprises program instructions. The program instructions are executable by a processor of a computer device to cause the computer device to receive a three-dimensional digital maxillary teeth model of a first set of one or more teeth of a maxilla of a patient. The teeth of the first set of teeth comprise first markings identifying one or more first surface contact sections of the teeth. In natural occlusion, the one or more first surface contact sections are in contact with one or more second surface contact sections of one or more antagonistic teeth of a mandible of the patient. A three-dimensional digital mandibular teeth model of a second set of one or more teeth of the mandible of the patient is received. The teeth of the second set of teeth comprise one or more second markings identifying one or more of the second surface contact sections of the teeth. The first and second surface contact sections comprised by the teeth of the first and second set teeth are identified using the first and second markings. The identified first and second surface contact sections are paired. The pairing comprises determining pairs of first and second surface contact sections contacting each other in natural occlusion. The three-dimensional digital maxillary teeth model and the three-dimensional digital mandibular teeth model are arranged in occlusion. For one or more pairs of antagonistic teeth comprised by the first and second set of teeth relative tooth positions of the antagonistic teeth of the individual pairs are corrected. The correcting of the relative tooth positions comprises establishing contacts between the first surface contact sections and second surface contact sections of the pairs of first and second surface contact sections comprised by the antagonistic teeth of the individual pairs of antagonistic teeth.

The program instructions provided by the computer program may further be executable by the processor of the computer device to cause the computer device to execute any of the aforementioned examples of the method for correcting relative tooth positions of antagonistic teeth in occlusion for matching a natural occlusion.

In another aspect, the invention relates to a system for correcting relative tooth positions of antagonistic teeth in occlusion for matching a natural occlusion comprising a computer device. The computer device comprises a processor and a memory storing program instructions executable by the processor. Execution of the program instructions by the processor causes the computer device to receive a three-dimensional digital maxillary teeth model of a first set of one or more teeth of a maxilla of a patient. The teeth of the first set of teeth comprise first markings identifying one or more first surface contact sections of the teeth. In natural occlusion, the one or more first surface contact sections are in contact with one or more second surface contact sections of one or more antagonistic teeth of a mandible of the patient. A three-dimensional digital mandibular teeth model of a second set of one or more teeth of the mandible of the patient is received. The teeth of the second set of teeth comprise one or more second markings identifying one or more of the second surface contact sections of the teeth. The first and second surface contact sections comprised by the teeth of the first and second set teeth are identified using the first and second markings. The identified first and second surface contact sections are paired. The pairing comprises determining pairs of first and second surface contact sections contacting each other in natural occlusion. The three-dimensional digital maxillary teeth model and the three-dimensional digital mandibular teeth model are arranged in occlusion. For one or more pairs of antagonistic teeth comprised by the first and second set of teeth relative tooth positions of the antagonistic teeth of the individual pairs are corrected. The correcting of the relative tooth positions comprises establishing contacts between the first surface contact sections and second surface contact sections of the pairs of first and second surface contact sections comprised by the antagonistic teeth of the individual pairs of antagonistic teeth.

Execution of the program instructions stored in the memory by the processor may further cause the computer device of the system to execute any of the aforementioned examples of the method for correcting relative tooth positions of antagonistic teeth in occlusion for matching a natural occlusion.

For example, the system further comprises an intraoral scanner. Execution of the program instructions by the processor further causing the computer device to control the intraoral scanner to acquire first scan data of the first set of teeth of the maxilla of the patient. The first sections of the teeth are marked with the first markings. The intraoral scanner is further controlled to acquire second scan data of the second set of teeth of the mandible of the patient. The second sections of the teeth are marked with the second markings. Using the first scan data, the three-dimensional digital maxillary teeth model is generated comprising the first markings. Using the second scan data, the three-dimensional digital mandibular teeth model is generated comprising the second markings.

For example, a computer device for correcting relative tooth positions of antagonistic teeth in occlusion for matching a natural occlusion may comprise a processor and a memory storing program instructions executable by the processor. Execution of the program instructions by the processor causes the computer device to receive a three-dimensional digital maxillary teeth model of a first set of one or more teeth of a maxilla of a patient. The teeth of the first set of teeth comprise first markings identifying one or more first surface contact sections of the teeth. In natural occlusion, the one or more first surface contact sections are in contact with one or more second surface contact sections of one or more antagonistic teeth of a mandible of the patient. A three-dimensional digital mandibular teeth model of a second set of one or more teeth of the mandible of the patient is received. The teeth of the second set of teeth comprise one or more second markings identifying one or more of the second surface contact sections of the teeth. The first and second surface contact sections comprised by the teeth of the first and second set teeth are identified using the first and second markings. The identified first and second surface contact sections are paired. The pairing comprises determining pairs of first and second surface contact sections contacting each other in natural occlusion. The three-dimensional digital maxillary teeth model and the three-dimensional digital mandibular teeth model are arranged in occlusion. For one or more pairs of antagonistic teeth comprised by the first and second set of teeth relative tooth positions of the antagonistic teeth of the individual pairs are corrected. The correcting of the relative tooth positions comprises establishing contacts between the first surface contact sections and second surface contact sections of the pairs of first and second surface contact sections comprised by the antagonistic teeth of the individual pairs of antagonistic teeth.

Execution of the program instructions stored in the memory by the processor may further cause the computer device to execute any of the aforementioned examples of the method for correcting relative tooth positions of antagonistic teeth in occlusion for matching a natural occlusion.

It is understood that one or more of the aforementioned embodiments may be combined as long as the combined embodiments are not mutually exclusive.

### BRIEF DESCRIPTION OF THE DRAWINGS

In the following, examples are described in greater detail making reference to the drawings in which:

FIG. 1 shows an exemplary connection of a tooth to an alveolar bone via a periodontal ligament;

FIG. 2 shows an exemplary three-dimensional digital maxillary teeth model and an exemplary three-dimensional digital mandibular teeth model;

FIG. 3 shows an exemplary articulating paper;

FIG. 4 shows the exemplary three-dimensional digital maxillary teeth model and three-dimensional digital mandibular teeth model arranged in preliminary occlusion;

FIG. 5 shows the exemplary three-dimensional digital maxillary teeth model and three-dimensional digital mandibular teeth model arranged in occlusion with relative tooth positions being corrected;

FIG. 6 shows a cross-sectional view of an exemplary pair of antagonistic teeth, the relative position of which is corrected;

FIG. 7 shows a cross-sectional view of an exemplary pair of antagonistic teeth, the relative position of which is corrected;

FIG. 8 shows a cross-sectional view of an exemplary pair of antagonistic teeth, the relative position of which is corrected;

FIG. 9 shows a cross-sectional view of an exemplary pair of antagonistic teeth, the relative position of which is corrected;

FIG. 10 shows an exemplary computer device for correcting relative tooth positions of antagonistic teeth in occlusion for matching a natural occlusion;

FIG. 11 shows an exemplary computer device for correcting relative tooth positions of antagonistic teeth in occlusion for matching a natural occlusion;

FIG. 12 shows an exemplary system for manufacturing a dental restoration element;

FIG. 13 shows a flowchart illustrating an exemplary method for correcting relative tooth positions of antagonistic teeth in occlusion for matching a natural occlusion;

FIG. 14 shows a flowchart illustrating an exemplary method for correcting relative tooth positions of antagonistic teeth in occlusion for matching a natural occlusion;

FIG. 15 shows a flowchart illustrating an exemplary method for correcting relative tooth positions of antagonistic teeth in occlusion for matching a natural occlusion;

FIG. 16 shows a flowchart illustrating an exemplary method for correcting relative tooth positions of antagonistic teeth in occlusion for matching a natural occlusion; and

FIG. 17 shows a flowchart illustrating an exemplary method for correcting relative tooth positions of antagonistic teeth in occlusion for matching a natural occlusion.

### DETAILED DESCRIPTION

in the following, similar elements are denoted by the same reference numerals.

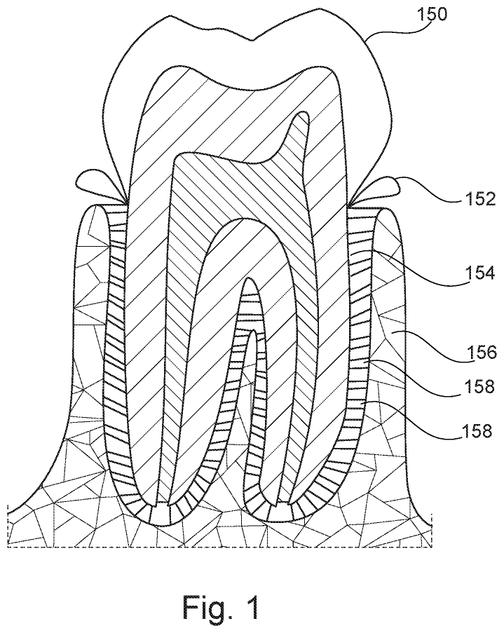

FIG. 1 shows a schematic cross-sectional view of a tooth 150 and its connection to an alveolar bone 156 via a PDL 158. The tooth 150 is attached to the alveolar bone 158, within which tooth 150 sits, by the PDL 158, i.e., a group of specialized connective tissue fibers that essentially attach the tooth 150 to the alveolar bone 158. These tissue fibers comprise principal fibers, loose connective tissue, blast and clast cells, oxytalan fibers and Cell Rest of Malassez. On one side the PDL 158 inserts into root cementum 154 of tooth 150 and on the other side onto the alveolar bone 156. PDL fibers 158 play a central role in load transfer between the tooth 150 and the alveolar bone 156 by absorbing and transmitting forces between tooth 150 and alveolar bone 156. Thereby, the PDL 158 helps the tooth 150 to withstand compressive forces that occur during chewing and remain embedded in the bone 156.

Due to the elasticity of the PDL 158, tooth 150 is enabled to move relative to the alveolar bone 156, e.g., when compressive forces are applied onto the tooth 150 during chewing. However, this relative movement has the effect that tooth 150 may, to a certain degree, alter its position relative to the alveolar bone 156 in occlusion, when an occlusal force is applied onto the tooth 150, compared to its position, when the mouth is open and no occlusal forces are applied.

In case of an intraoral scan, in order to be able to scan the full tooth 150, i.e., also occlusal and oral surfaces of the tooth 150, scan data of tooth 150 may be acquired, while the patient's mouth is open. In this case, the patient's teeth are not in occlusion during data acquisition. When occlusion is established, e.g., during chewing or at rest, a certain degree of compressive forces acts upon tooth 150 resulting in a slight shift of the individual tooth position relative the alveolar bone 156 and/or the gingiva 152 will occur. Therefore, the relative position of tooth 150 may differ in occlusion compared to its relative position, when the scan data is acquired.

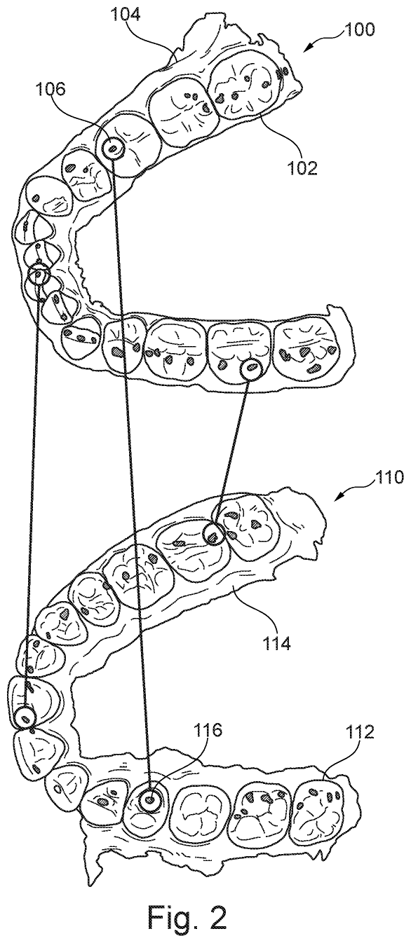

FIG. 2 shows a three-dimensional digital maxillary teeth model 110 of a first set of one or more teeth 112 of a maxilla of a patient as well as a three-dimensional digital mandibular teeth model 100 of a second set of one or more teeth 102 of a mandible of the patient. The three-dimensional digital maxillary teeth model 110 and three-dimensional digital mandibular teeth model 100 may, e.g., be generated using scan data of the patient's maxilla and mandible, respectively, e.g., using an intraoral scanner. The three-dimensional digital maxillary teeth model 110 may, e.g., be segmented resulting in a plurality of individual a three-dimensional digital maxillary tooth models of the maxillary teeth 112 and/or a three-dimensional digital maxillary gingiva model 114 of the maxillary gingiva. The three-dimensional digital mandibular teeth model 100 may, e.g., be segmented resulting in a plurality of individual a three-dimensional digital mandibular tooth models of the mandibular teeth 102 and/or a three-dimensional digital mandibular gingiva model 104 of the mandibular gingiva.

The teeth 112 of the first set of teeth 112 comprise first markings identifying one or more first surface contact sections 116 of the teeth 112. In natural occlusion, the one or more first surface contact sections 116 are in contact with one or more second surface contact sections 106 of one or more antagonistic teeth 102 of the mandible. The teeth 102 of the second set of teeth 102 comprise one or more second markings identifying one or more of the second surface contact sections 106 of the teeth 102. The first and second surface contact sections 116, 106 comprised by the teeth 112, 102 of the first and second set teeth 112, 102 are identified using the first and second markings. The identified first and second surface contact sections 116, 106 are paired as indicated in FIG. 2. The pairing comprises determining pairs of first and second surface contact sections 106,116 contacting each other in natural occlusion.

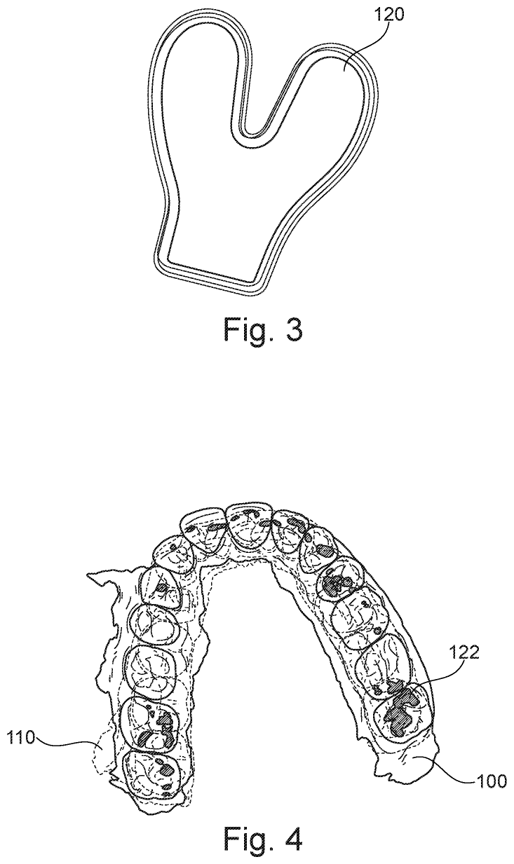

FIG. 3 shows an exemplary articulating paper 120 used for marking the first and second contact sections 116, 106 of FIG. 2. The first and second markings may, e.g., be generated on the surface of the patient's teeth 112, 102 of FIG. 2 prior to the acquisition of scan data using the articulating paper 120, on which the patient bites. The articulating paper 120 may, e.g., be provided in a form roughly corresponding to the arch-like of a dental arch. When the patient bites onto the articulating paper 120, the natural occlusion may be assumed by the teeth 112, 102. Where the teeth 112, 102 get in contact with the articulating paper 120, they may be marked using a marking color comprised by the articulating paper 120. The articulating paper 120 may, e.g., have a thickness of 200 μm. For example, Bausch® Articulating Paper BK 03 blue 200μ may be used. The scan data of the intraoral scan may be indicative of the resulting first and second markings. Thus, when generating the three-dimensional digital mandibular teeth model 100 and the three-dimensional digital maxillary teeth model 110 using the acquired scan data, the generated models 100, 110 may comprise the first and second markings, e.g., be indicative of the contact sections 106, 116 as shown in FIG. 2.

FIG. 4 shows the three-dimensional digital maxillary teeth model 110 and the three-dimensional digital mandibular teeth model 100 arranged in occlusion, i.e., preliminary occlusion. For example, additional occlusion scan data of the patient's dentition in occlusion may be acquired. The additional scan data may, e.g., be indicative of a relative position of one or more teeth 112 of the first set 112 of teeth comprised by the three-dimensional digital maxillary teeth model 110 relative to one or more teeth 102 of the second set of teeth 102 comprised by the three-dimensional digital mandibular teeth model 100. Thus, the occlusion scan data may be used for arranging the three-dimensional digital maxillary teeth model 110 relative to the three-dimensional digital mandibular teeth model 100 in a relative position, such that the respective teeth 112 of the first set of teeth 112 comprised by the three-dimensional digital maxillary teeth model 110 are arranged in the relative position relative to the teeth 102 of the second set of teeth 102 comprised by the three-dimensional digital mandibular teeth model 100 as indicated by the occlusion scan data. Since the relative position of the teeth 102 of the three-dimensional digital mandibular teeth model 100 and the teeth 112 of three-dimensional digital maxillary teeth model 110 is a position in three dimensions, while the occlusion scan data scanning the teeth 112, 102 in occlusion from a vestibular direction may only provide two-dimensional information. Thus, the position information regarding the occlusion may only be preliminary, while the precise position in three-dimensional space may be determined using the first and second markings. Compressive forces occurring in occlusion may result in a slight movement of the teeth 112, 102 towards the alveolar bones, in which they are arranged. This movement is enabled by the periodontal ligament as a flexible connecting element arranged in between the static alveolar bones and teeth. Neglecting this movement, when arranging the three-dimensional digital mandibular teeth model 102 and the three-dimensional digital mandibular teeth model 112 in preliminary occlusion, it may be expected that interpenetrations 122 may occur. These interpenetrations 122 may, e.g., occur for all the pairs of first and second contact section. By correcting relative tooth positions of antagonistic teeth in occlusion for matching the natural occlusion, the movement of the teeth 112, 102 towards the alveolar bones enabled by the periodontal ligament may, e.g., be effectively taken into account.

For example, the additional occlusion scan data of the patient's may, e.g., be indicative of a relative position of a three-dimensional digital maxillary gingiva model 114 comprised by the three-dimensional digital maxillary teeth model 110 relative to a three-dimensional digital mandibular gingiva model 104 comprised by the three-dimensional digital mandibular teeth model 100. Thus, the occlusion scan data may be used for arranging the three-dimensional digital maxillary teeth model 110 relative to the three-dimensional digital mandibular teeth model 100 in a relative position, such that the three-dimensional digital maxillary gingiva model 114 comprised by the three-dimensional digital maxillary teeth model 110 is arranged in the relative position relative to the three-dimensional digital mandibular gingiva model 104 comprised by the three-dimensional digital mandibular teeth model 100 as indicated by the addition scan data.

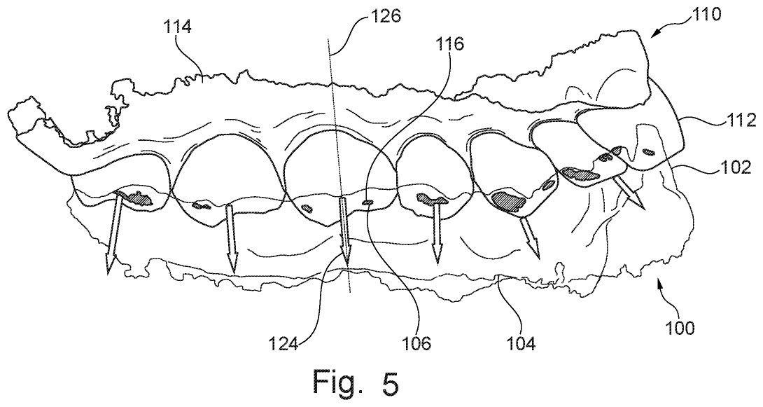

FIG. 5 shows the three-dimensional digital maxillary teeth model 110 and the three-dimensional digital mandibular teeth model 100 arranged in occlusion. For one or more pairs of antagonistic teeth 112, 102 comprised by the first and second set of teeth 102, 112 relative tooth positions of the antagonistic teeth 112, 102 of the individual pairs are corrected. The correcting of the relative tooth positions comprises establishing contacts between the first surface contact sections 116 and second surface contact sections 106 of the pairs of first and second surface contact sections 116, 106 comprised by the antagonistic teeth 112, 102 of the individual pairs of antagonistic teeth 112, 102. The correcting of the tooth positions may comprise moving, e.g., the maxillary teeth 112 each in a direction of movement 125 along a tooth axis 126 of the respective maxillary tooth 112 toward the antagonistic mandibular tooth 102. By moving the maxillary teeth 112, e.g., contacts between first and second contact sections 116, 106 of the respective antagonistic teeth 112, 102 may be established.

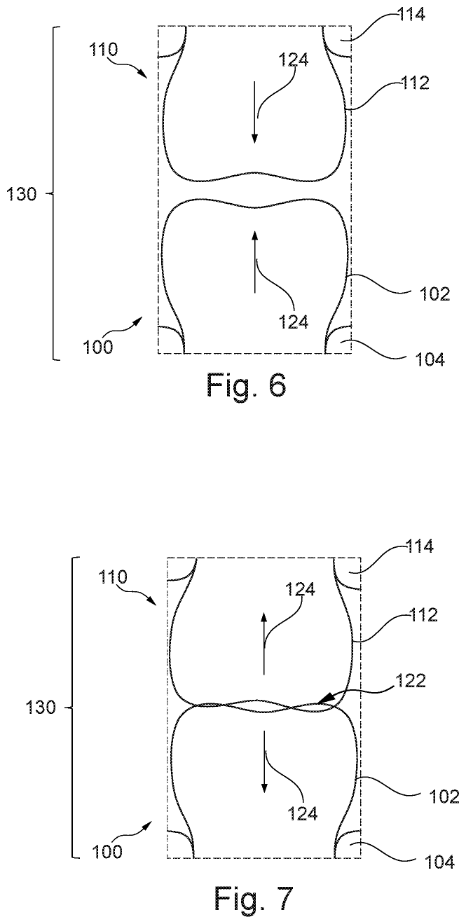

FIG. 6 shows an exemplary pair 130 of antagonistic teeth 112, 102 comprised by a three-dimensional digital maxillary teeth model 110 and a three-dimensional digital mandibular teeth model 100, respectively. The three-dimensional digital maxillary teeth model 110 and the three-dimensional digital mandibular teeth model 100 may further comprise a three-dimensional digital maxillary gingiva model 114 and a three-dimensional digital mandibular gingiva model 104, respectively. Occlusal surfaces of the teeth 112, 102 of the exemplary pair 130 of antagonistic teeth 112, 102 arranged in occlusion are, e g, spaced apart from each other without contact. The correcting of the tooth positions may, e.g., comprises moving the antagonistic teeth 112, 102 of the pair 130 towards each other along the tooth axes of the respective teeth 112, 102 in directions of movement indicated by arrows 124, until one or more contacts between the teeth 112, 102 are established. By moving the antagonistic teeth 112, 102 of the pair 130 towards each other along the tooth axes of the respective teeth 112, 102 contacts matching the contacts of the teeth 112, 102 in natural occlusion may be established.

FIG. 7 shows an exemplary pair 130 of antagonistic teeth 112, 102 comprised by a three-dimensional digital maxillary teeth model 110 and a three-dimensional digital mandibular teeth model 100, respectively. The three-dimensional digital maxillary teeth model 110 and the three-dimensional digital mandibular teeth model 100 may further comprise a three-dimensional digital maxillary gingiva model 114 and a three-dimensional digital mandibular gingiva model 104, respectively. The teeth 112, 102 of the exemplary pair 130 of antagonistic teeth 112, 102 arranged in occlusion are, e.g., intersecting each other resulting in one or more interpenetrations 112. The correcting of the tooth positions may, e.g., comprises moving the antagonistic teeth 112, 102 of the pair 130 away from each other along the tooth axes of the respective teeth 112, 102 in directions of movement indicated by arrows 124, until only one or more surface contacts between the teeth 112, 102 remain. By moving the antagonistic teeth 112, 102 of the pair 130 away from each other along the tooth axes of the respective teeth 112, 102 surface contacts matching the contacts of the teeth 112, 102 in natural occlusion may be established.

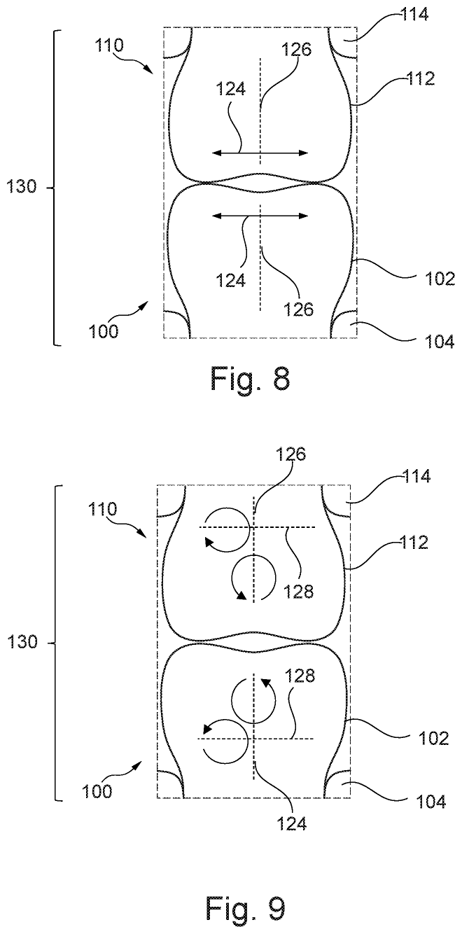

FIG. 8 shows an exemplary pair 130 of antagonistic teeth 112, 102 comprised by a three-dimensional digital maxillary teeth model 110 and a three-dimensional digital mandibular teeth model 100, respectively. The three-dimensional digital maxillary teeth model 110 and the three-dimensional digital mandibular teeth model 100 may further comprise a three-dimensional digital maxillary gingiva model 114 and a three-dimensional digital mandibular gingiva model 104, respectively. The correcting of the tooth positions may, e.g., comprises moving the teeth 112, 102 of pair 130 perpendicular to the tooth axes 126 of the respective teeth 112, 102 in directions of movements indicated by arrows 124. Thus, the position of the respective teeth 112, 102 may, e.g., be adjusted in second and/or third directions 124 perpendicular to the tooth axes 126 defining first directions. The second and third directions 124 may extend perpendicular to each other. Moving the teeth 112, 102 along the tooth axes 126 may result in a one-dimensional adjustment of the positions of the teeth 112, 102. Moving teeth 112. 102 of the pairs 130 perpendicular to the tooth axes 126 may allow for an adjustment in one or more other directions 124.

FIG. 9 shows an exemplary pair 130 of antagonistic teeth 112, 102 comprised by a three-dimensional digital maxillary teeth model 110 and a three-dimensional digital mandibular teeth model 100, respectively. The three-dimensional digital maxillary teeth model 110 and the three-dimensional digital mandibular teeth model 100 may further comprise a three-dimensional digital maxillary gingiva model 114 and a three-dimensional digital mandibular gingiva model 104, respectively. The correcting of the tooth positions may, e.g., comprises rotating one or more of the teeth 112, 102 of pair 130 around one or more axes of rotation 126, 128 of the respective teeth 112, 102. Thus, also rotations of the teeth 112, 102 may be used for establishing the surface contacts between the teeth 112, 102 matching the contacts of the natural occlusion. For example, the one or more axes of rotation 126, 128 may comprise the tooth axis 126 of the respective tooth and/or one or more axes 128 extending perpendicular to the tooth axis 126, e.g., an axis extending in vestibula direction of the respective tooth 112, 102 and/or an axis extending in mesial direction of the respective tooth 112, 102.

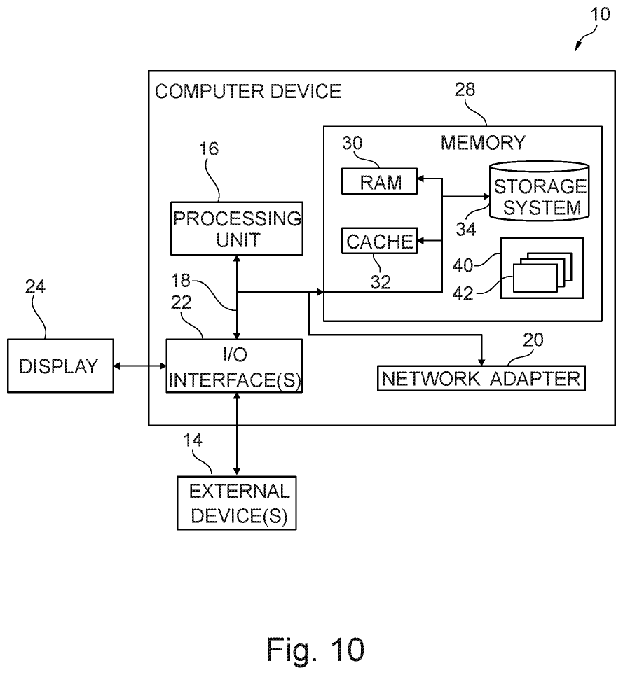

FIG. 10 shows a schematic diagram of an exemplary computer device 10 for correcting relative tooth positions of antagonistic teeth in occlusion for matching a natural occlusion. The computer device 10 may be operational with numerous other general-purpose or special-purpose computing system environments or configurations. Computer device 10 may be described in the general context of computer device executable instructions, such as program modules comprising executable program instructions, being executable by the computer device 10. Generally, program modules may include routines, programs, objects, components, logic, data structures, and so on that perform particular tasks or implement particular abstract data types. Computer device 10 may be practiced in distributed computing environments where tasks are performed by remote processing devices that are linked through a communications network. In a distributed computing environment, program modules may be located in both local and remote computer device storage media including memory storage devices.

In FIG. 10, computer device 10 is shown in the form of a general-purpose computing device. The components of computer device 10 may include, but are not limited to, one or more processors or processing units 16, a system memory 28, and a bus 18 that couples various system components including system memory 28 to processor 16. Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer device 10 may comprise a variety of computer device readable storage media. Such media may be any available storage media accessible by computer device 10, and include both volatile and non-volatile storage media, removable and non-removable storage media.

A system memory 28 may include computer device readable storage media in the form of volatile memory, such as random-access memory (RAM) 30 and/or cache memory 32. Computer device 10 may further include other removable/non-removable, volatile/non-volatile computer device storage media. For example, storage system 34 may be provided for reading from and writing to a non-removable, non-volatile magnetic media also referred to as a hard drive. For example, a magnetic disk drive for reading from and writing to a removable, non-volatile magnetic disk, e.g., a floppy disk, and an optical disk drive for reading from or writing to a removable, non-volatile optical disk such as a CD-ROM, DVD-ROM or other optical storage media may be provided. In such instances, each storage medium may be connected to bus 18 by one or more data media interfaces. Memory 28 may, e.g., include a three-dimensional digital maxillary teeth model of a first set of one or more teeth of a maxilla of a patient. The teeth of the first set of teeth comprise first markings identifying one or more first surface contact sections of the teeth. In natural occlusion, the one or more first surface contact sections are in contact with one or more second surface contact sections of one or more antagonistic teeth of a mandible of the patient. Memory 28 may, e.g., include a three-dimensional digital mandibular teeth model of a second set of one or more teeth of the mandible of the patient. The teeth of the second set of teeth comprise one or more second markings identifying one or more of the second surface contact sections of the teeth.

Memory 28 may, e.g., include scan data of a patient's mouth from an intraoral scan. The scan data may, e.g., comprise first scan data of the first set of teeth of the maxilla of the patient. The first sections of the teeth are marked with the first markings. The scan data may, e.g., comprise second scan data of the second set of teeth of the mandible of the patient is acquired using the intraoral scanner. The second sections of the teeth are marked with the second markings. The first scan data may, e.g., be used for generating the three-dimensional digital maxillary teeth model comprising the first markings. The second scan data may, e.g., be used for generating the three-dimensional digital mandibular teeth model comprising the second markings. The scan data may, e.g., in addition comprise occlusion scan data of the first set of teeth, which are in occlusion with the second set of teeth. The occlusion scan data may be used for arranging of the three-dimensional digital maxillary teeth model and the three-dimensional digital mandibular teeth model in preliminary occlusion.

Program 40 may have a set of one or more program modules 42 and by way of example be stored in memory 28. The program modules 42 may comprise an operating system, one or more application programs, other program modules, and/or program data. Each of these program modules 42, i.e., the operating system, the one or more application programs, the other program modules, and/or the program data or some combination thereof, may include an implementation of a networking environment. One or more of the program modules 42 may be configured for correcting relative tooth positions of antagonistic teeth in occlusion for matching a natural occlusion. The program modules 42 may, e.g., be configured to control the computer device 10 to receive a three-dimensional digital maxillary teeth model of a first set of one or more teeth of a maxilla of a patient. The teeth of the first set of teeth comprise first markings identifying one or more first surface contact sections of the teeth. In natural occlusion, the one or more first surface contact sections are in contact with one or more second surface contact sections of one or more antagonistic teeth of a mandible of the patient. A three-dimensional digital mandibular teeth model of a second set of one or more teeth of the mandible of the patient is received. The teeth of the second set of teeth comprise one or more second markings identifying one or more of the second surface contact sections of the teeth. The first and second surface contact sections comprised by the teeth of the first and second set teeth are identified using the first and second markings. The identified first and second surface contact sections are paired. The pairing comprises determining pairs of first and second surface contact sections contacting each other in natural occlusion. The three-dimensional digital maxillary teeth model and the three-dimensional digital mandibular teeth model are arranged in occlusion.

One of the program modules 42 may, e.g., further be configured for generating a three-dimensional digital dental restoration model using the relative tooth positions determined for the antagonistic teeth matching the relative positions in natural occlusion.

Computer device 10 may further communicate with one or more external devices 14 such as a keyboard, a pointing device, like a mouse, and a display 24 enabling a user to interact with computer device 10. Such communication can occur via input/output (I/O) interfaces 22. Computer device 10 may further communicate with one or more networks such as a local area network (LAN), a general wide area network (WAN), and/or a public network, like the Internet, via network adapter 20. Network adapter 20 may communicate with other components of computer device 10 via bus 18. It should be understood that although not shown, other hardware and/or software components could be used in conjunction with computer device 10.

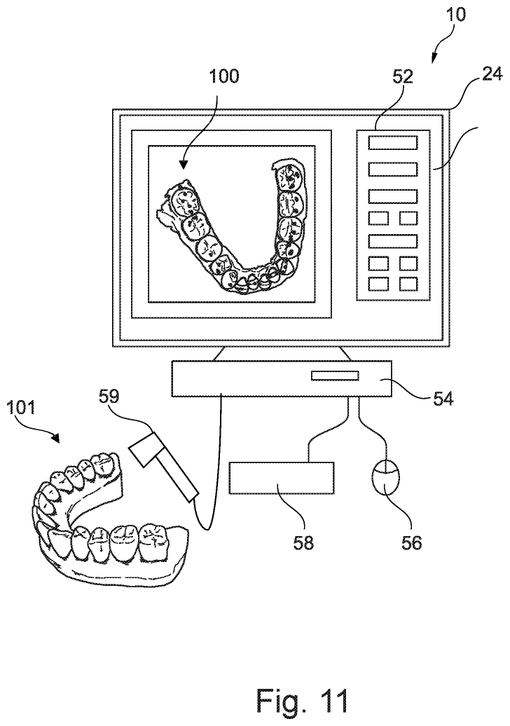

FIG. 11 shows an exemplary computer device 10 for correcting relative tooth positions of antagonistic teeth in occlusion for matching a natural occlusion. The computer device 10 may, e.g., be configured as shown in FIG. 10. The computer device 10 may comprise a hardware component 54 comprising one or more processors as well as a memory storing machine-executable program instructions. Execution of the program instructions by the one or more processors may cause the one or more processors to control the computer device 10 to correct relative tooth positions of antagonistic teeth in occlusion for matching a natural occlusion.

The computer device 10 may further comprise one or more input devices, like a keyboard 58 and a mouse 56, enabling a user to interact with the computer device 10. Furthermore, the computer device 10 may comprise one or more output devices, like a display 24 providing a graphical user interface 50 with control elements 52, e.g., GUI elements, enabling the user to control the correcting relative tooth positions of antagonistic teeth in occlusion for matching a natural occlusion. The computer device 10 may further comprise an intraoral scanner 59, e.g., configured for scanning a patient's oral cavity comprising, e.g., a mandible 101 of the patient and generating, e.g., a three-dimensional digital mandibular teeth model 100. The same way, a maxilla may be scanned and a three-dimensional digital maxillary teeth model generated.

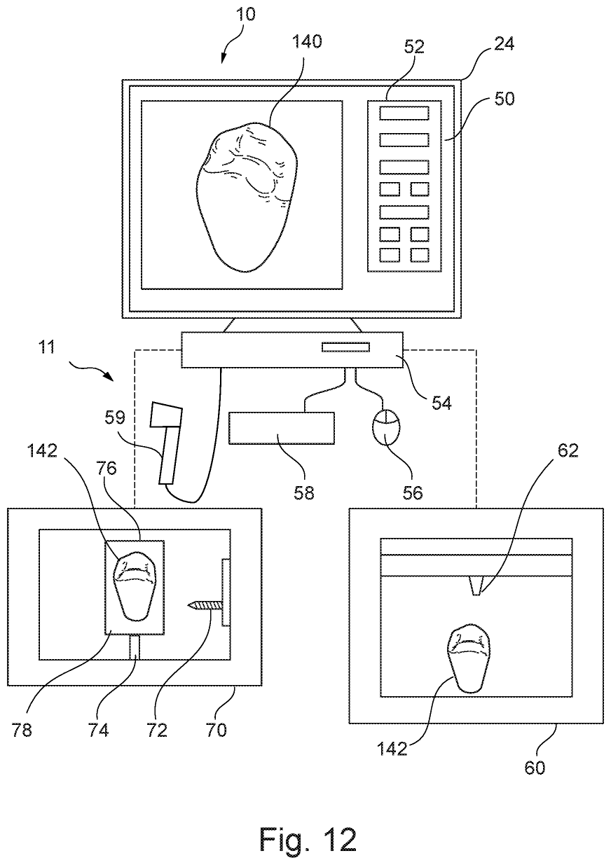

FIG. 12 shows an exemplary manufacturing system 11 for manufacturing a dental restoration element 142. A three-dimensional digital dental restoration model 140 defining the dental restoration element 142 may be provided. This three-dimensional digital dental restoration model 140 may, e.g., be used as a template for manufacturing the dental restoration element 142 as a physical copy of the template. For generating the three-dimensional digital dental restoration model 140, e.g., the relative tooth positions determined for the antagonistic teeth matching the relative positions in natural occlusion may be used.

The manufacturing system 11 may comprise the computer device 10 of FIG. 10. The computer device 10 may further be configured to control one or more manufacturing devices 60, 70. For example, the manufacturing system 11 may comprise a manufacturing device in form of a machining device 70 controlled by the computer device 10. The machining device 70 may be configured to machining a blank 76 using one or more machining tools 72. The blank 76 of raw material 78, may be provided using a holding device 74 and cut into a desired shape and size of the element to be manufactured, e.g., the dental restoration element 142. The machining tool 72 may, e.g., be a milling tool.

For example, the manufacturing system 11 may comprise a manufacturing device in form of a 3D printing device 60. The 3D printing device 60 may be controlled by the computer device 10 and configured to print an element to be manufactured, e.g., the dental restoration element. The 3D printing device 60 may comprise a printing element 62 configured to print the respective element, like the dental restoration element 142, layer by layer. The printing element 62 may, e.g., comprise a nozzle configured for distributing printing material.

In case the element to be manufactured using the 3D printing device 60 is made using metal, the 3D printing device 60 may, e.g., be configured for executing selective laser sintering or melting. Selective laser sintering uses a laser for sintering a powdered material, aiming the laser automatically at points in space defined by a three-dimensional digital model of the element to be printed. The laser energy may result in a local sintering or melting of the powdered material, binding the material together to create a solid structure. For example, the printing element 62 of the 3D printing device 60 may comprise a laser and/or a distributing device for distributing the powdered material.

For example, the three-dimensional digital restoration model may be used as a positive to define a negative of the physical dental restoration element in form of a negative three-dimensional digital restoration model. The negative three-dimensional digital restoration model may be used to manufacture, e.g., using machining device 70 or 3D printing device 60, a casting matrix. The casting matrix may be configured for casting the physical dental restoration element 142 by inserting restoration material into the casting matrix and curing the inserted restoration material.

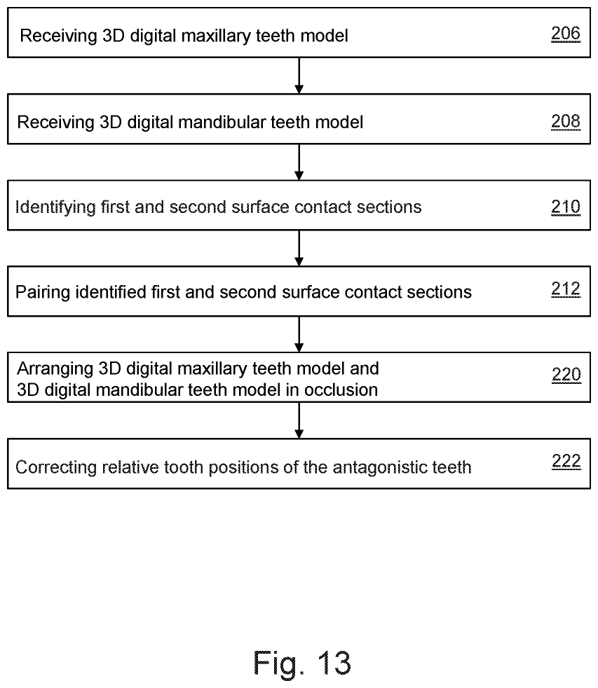

FIG. 13 shows an exemplary method for correcting relative tooth positions of antagonistic teeth in occlusion for matching a natural occlusion. In block 206, a three-dimensional digital maxillary teeth model of a first set of one or more teeth of a maxilla of a patient is received. The teeth of the first set of teeth comprise first markings identifying one or more first surface contact sections of the teeth. In natural occlusion, the one or more first surface contact sections are in contact with one or more second surface contact sections of one or more antagonistic teeth of a mandible of the patient. In block 208, a three-dimensional digital mandibular teeth model of a second set of one or more teeth of the mandible of the patient is received. The teeth of the second set of teeth comprise one or more second markings identifying one or more of the second surface contact sections of the teeth.

In block 210, the first and second surface contact sections comprised by the teeth of the first and second set teeth are identified using the first and second markings. In block 212, the identified first and second surface contact sections are paired. The pairing comprises determining pairs of first and second surface contact sections contacting each other in natural occlusion.

In block 220, the three-dimensional digital maxillary teeth model and the three-dimensional digital mandibular teeth model are arranged in occlusion. In block 222, for one or more pairs of antagonistic teeth comprised by the first and second set of teeth relative tooth positions of the antagonistic teeth of the individual pairs are corrected. The correcting of the relative tooth positions comprises establishing contacts between the first surface contact sections and second surface contact sections of the pairs of first and second surface contact sections comprised by the antagonistic teeth of the individual pairs of antagonistic teeth.

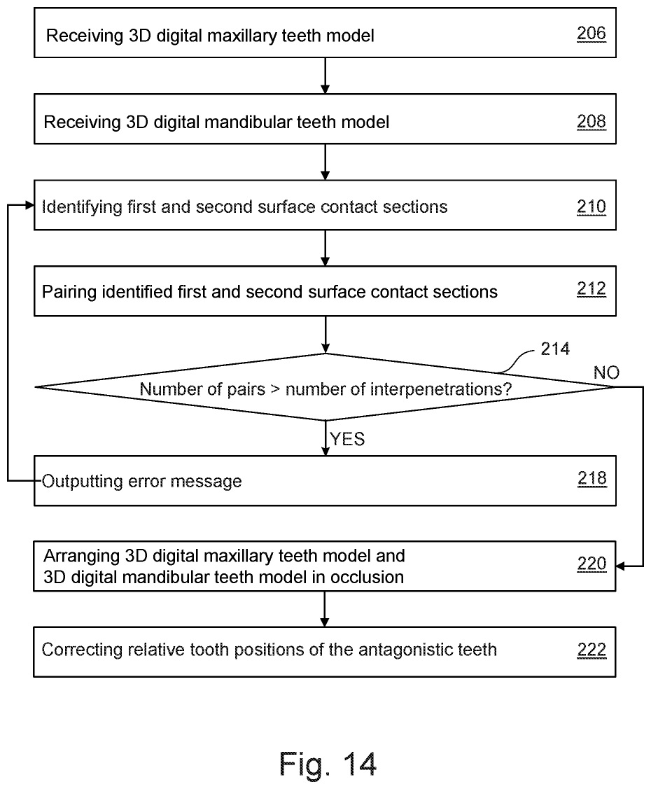

FIG. 14 shows an exemplary method for correcting relative tooth positions of antagonistic teeth in occlusion for matching a natural occlusion. In block 206, a three-dimensional digital maxillary teeth model of a first set of one or more teeth of a maxilla of a patient is received. The teeth of the first set of teeth comprise first markings identifying one or more first surface contact sections of the teeth. In natural occlusion, the one or more first surface contact sections are in contact with one or more second surface contact sections of one or more antagonistic teeth of a mandible of the patient. In block 208, a three-dimensional digital mandibular teeth model of a second set of one or more teeth of the mandible of the patient is received. The teeth of the second set of teeth comprise one or more second markings identifying one or more of the second surface contact sections of the teeth.

In block 210, the first and second surface contact sections comprised by the teeth of the first and second set teeth are identified using the first and second markings. In block 212, the identified first and second surface contact sections are paired. The pairing comprises determining pairs of first and second surface contact sections contacting each other in natural occlusion.

In block 214, it is checked, whether a of pairs of first and second surface contact sections exceeds a number of interpenetrations between the teeth of the first and second sets of teeth in occlusion by a predefined first amount. In case the number of pairs exceeds the number of interpenetrations by the predefined first amount, the method is continued with block 218. In block 218, an error message is output. Furthermore, the identifying of block 210 and the pairing of block 214 are repeated. Then, it is checked again in block 214, whether the number of pairs resulting from the repeated pairing exceeds the number of interpenetrations by the predefined first amount.

In case the number of pairs does not exceed the number of interpenetrations by the predefined first amount, the method is continued with block 220. In block 220, the three-dimensional digital maxillary teeth model and the three-dimensional digital mandibular teeth model are arranged in occlusion. In block 222, for one or more pairs of antagonistic teeth comprised by the first and second set of teeth relative tooth positions of the antagonistic teeth of the individual pairs are corrected. The correcting of the relative tooth positions comprises establishing contacts between the first surface contact sections and second surface contact sections of the pairs of first and second surface contact sections comprised by the antagonistic teeth of the individual pairs of antagonistic teeth.

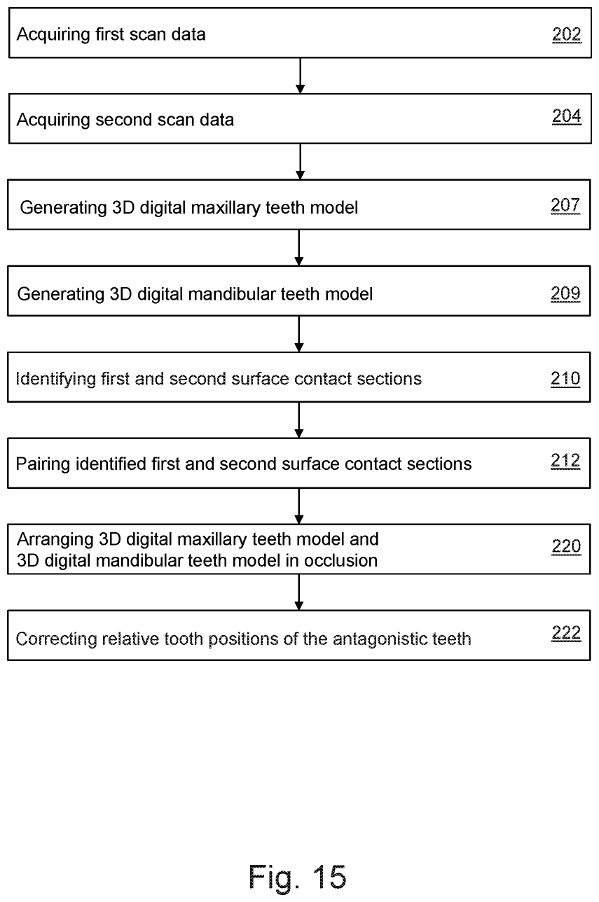

FIG. 15 shows an exemplary method for correcting relative tooth positions of antagonistic teeth in occlusion for matching a natural occlusion. In block 202, first scan data of a first set of one or more teeth of a maxilla of a patient is acquired using an intraoral scanner. The teeth of the first set of teeth comprise first markings identifying one or more first surface contact sections of the teeth. In natural occlusion, the one or more first surface contact sections are in contact with one or more second surface contact sections of one or more antagonistic teeth of a mandible of the patient. In block 204, second scan data of a second set of one or more teeth of the mandible of the patient is acquired using the intraoral scanner. The teeth of the second set of teeth comprise one or more second markings identifying one or more of the second surface contact sections of the teeth.

In block 207, a three-dimensional digital maxillary teeth model comprising the first markings is generated using the first scan data. Thereby, the three-dimensional digital maxillary teeth model is received. In block 209, a three-dimensional digital mandibular teeth model comprising the second markings is generated using the second scan data. Thereby, the three-dimensional digital mandibular teeth model is received.

In block 210, the first and second surface contact sections comprised by the teeth of the first and second set teeth are identified using the first and second markings. In block 212, the identified first and second surface contact sections are paired. The pairing comprises determining pairs of first and second surface contact sections contacting each other in natural occlusion.

In block 220, the three-dimensional digital maxillary teeth model and the three-dimensional digital mandibular teeth model are arranged in occlusion. In block 222, for one or more pairs of antagonistic teeth comprised by the first and second set of teeth relative tooth positions of the antagonistic teeth of the individual pairs are corrected. The correcting of the relative tooth positions comprises establishing contacts between the first surface contact sections and second surface contact sections of the pairs of first and second surface contact sections comprised by the antagonistic teeth of the individual pairs of antagonistic teeth.

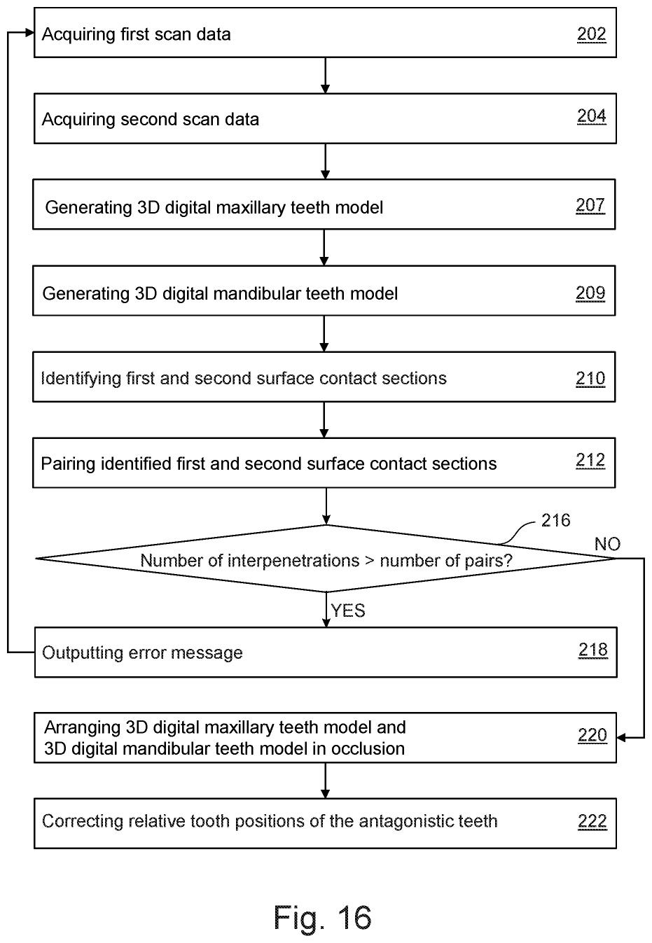

FIG. 16 shows an exemplary method for correcting relative tooth positions of antagonistic teeth in occlusion for matching a natural occlusion. In block 202, first scan data of a first set of one or more teeth of a maxilla of a patient is acquired using an intraoral scanner. The teeth of the first set of teeth comprise first markings identifying one or more first surface contact sections of the teeth. In natural occlusion, the one or more first surface contact sections are in contact with one or more second surface contact sections of one or more antagonistic teeth of a mandible of the patient. In block 204, second scan data of a second set of one or more teeth of the mandible of the patient is acquired using the intraoral scanner. The teeth of the second set of teeth comprise one or more second markings identifying one or more of the second surface contact sections of the teeth.

In block 207, a three-dimensional digital maxillary teeth model comprising the first markings is generated using the first scan data. Thereby, the three-dimensional digital maxillary teeth model is received. In block 209, a three-dimensional digital mandibular teeth model comprising the second markings is generated using the second scan data. Thereby, the three-dimensional digital mandibular teeth model is received.

In block 210, the first and second surface contact sections comprised by the teeth of the first and second set teeth are identified using the first and second markings. In block 212, the identified first and second surface contact sections are paired. The pairing comprises determining pairs of first and second surface contact sections contacting each other in natural occlusion.

In block 216, it is checked, whether a number of interpenetrations between the teeth of the first and second sets of teeth in occlusion exceeds a number of pairs of first and second surface contact sections determined by a predefined second amount. In case the number of interpenetrations exceeds the number of pairs by the predefined second amount, the method is continued with block 218. In block 218, an error message is output. Furthermore, the acquiring of the first and second scan data in blocks 202 and 204 as well as the generating of the three-dimensional digital maxillary teeth model in block 207 and the three-dimensional digital mandibular teeth model in block 209 is repeated. The identifying of block 210 and the pairing of block 214 are repeated using the re-generated three-dimensional digital maxillary teeth model and the re-generated three-dimensional digital mandibular teeth model. Then, it is checked again in block 216, whether the number of interpenetrations exceeds the number of pairs resulting from the repeated pairing by the predefined second amount.

In case the number of interpenetrations exceeds the number of pairs by the predefined second amount, the method is continued with block 220. In block 220, the three-dimensional digital maxillary teeth model and the three-dimensional digital mandibular teeth model are arranged in occlusion. In block 222, for one or more pairs of antagonistic teeth comprised by the first and second set of teeth relative tooth positions of the antagonistic teeth of the individual pairs are corrected. The correcting of the relative tooth positions comprises establishing contacts between the first surface contact sections and second surface contact sections of the pairs of first and second surface contact sections comprised by the antagonistic teeth of the individual pairs of antagonistic teeth.

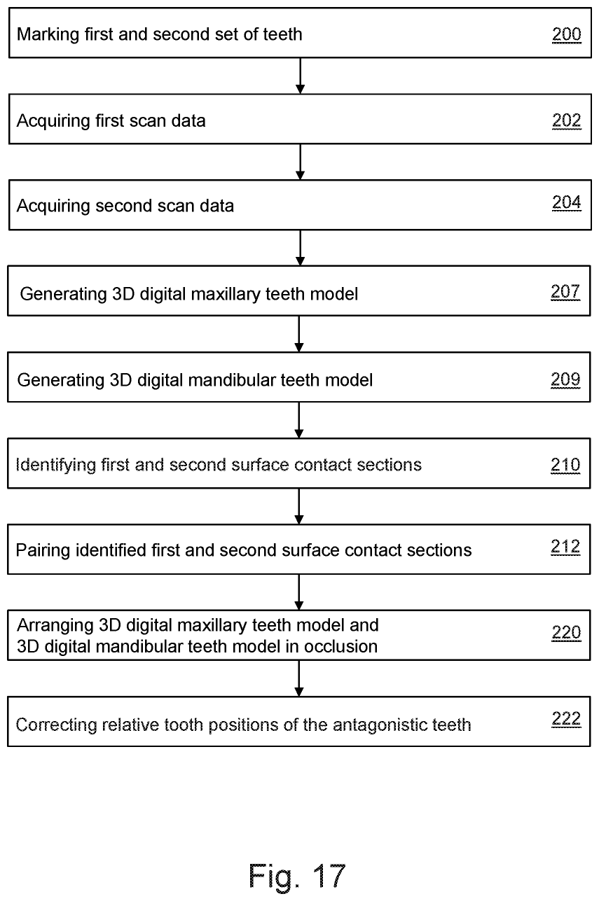

FIG. 17 shows an exemplary method for correcting relative tooth positions of antagonistic teeth in occlusion for matching a natural occlusion. In block 200, one or more first surface contact sections of one or more teeth of a first set of one or more teeth of a maxilla of a patient are marked with first markings, while one or more second surface contact sections of one or more teeth of a second set of one or more teeth of a mandible of the patient are marked with second markings. In natural occlusion, the one or more first surface contact sections are in contact with one or more second surface contact sections of one or more antagonistic teeth of a mandible of the patient. For marking the first and second marking, e.g., articulating paper is used, on which the patient bites.

In block 202, first scan data of the first set of one or more teeth of the maxilla of the patient is acquired using an intraoral scanner. The teeth of the first set of teeth comprise the first markings identifying the one or more first surface contact sections of the teeth. In block 204, second scan data of the second set of one or more teeth of the mandible of the patient is acquired using the intraoral scanner. The teeth of the second set of teeth comprise the one or more second markings identifying the one or more second surface contact sections of the teeth.

In block 207, a three-dimensional digital maxillary teeth model comprising the first markings is generated using the first scan data. Thereby, the three-dimensional digital maxillary teeth model is received. In block 209, a three-dimensional digital mandibular teeth model comprising the second markings is generated using the second scan data. Thereby, the three-dimensional digital mandibular teeth model is received.

In block 210, the first and second surface contact sections comprised by the teeth of the first and second set teeth are identified using the first and second markings. In block 212, the identified first and second surface contact sections are paired. The pairing comprises determining pairs of first and second surface contact sections contacting each other in natural occlusion.

In block 220, the three-dimensional digital maxillary teeth model and the three-dimensional digital mandibular teeth model are arranged in occlusion. In block 222, for one or more pairs of antagonistic teeth comprised by the first and second set of teeth relative tooth positions of the antagonistic teeth of the individual pairs are corrected. The correcting of the relative tooth positions comprises establishing contacts between the first surface contact sections and second surface contact sections of the pairs of first and second surface contact sections comprised by the antagonistic teeth of the individual pairs of antagonistic teeth.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

A single processor or other unit may fulfill the functions of several items recited in the claims. A computer program may be stored/distributed on a suitable medium, such as an optical storage medium or a solid-state medium supplied together with or as part of other hardware, but may also be distributed in other forms, such as via the Internet or other wired or wireless telecommunication systems.

As will be appreciated by one skilled in the art, aspects of the present invention may be embodied as an apparatus, method, computer program or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer executable code embodied thereon. A computer program comprises the computer executable code or “program instructions”.

Any combination of one or more computer readable medium(s) may be utilized. The computer readable medium may be a computer readable signal medium or a computer readable storage medium. A “computer-readable storage medium” as used herein encompasses any tangible storage medium which may store instructions which are executable by a processor of a computing device. The computer-readable storage medium may be referred to as a computer-readable non-transitory storage medium. The computer-readable storage medium may also be referred to as a tangible computer readable medium. For example, a computer-readable storage medium may also be able to store data which is able to be accessed by the processor of the computing device. Examples of computer-readable storage media include, but are not limited to: a floppy disk, a magnetic hard disk drive, a solid-state hard disk, flash memory, a USB thumb drive, Random Access Memory (RAM), Read Only Memory (ROM), an optical disk, a magneto-optical disk, and the register file of the processor. Examples of optical disks include Compact Disks (CD) and Digital Versatile Disks (DVD), for example CD-ROM, CD-RW, CD-R, DVD-ROM, DVD-RW, or DVD-R disks. A further example of an optical disk may be a Blu-ray disk. The term computer readable-storage medium also refers to various types of recording media capable of being accessed by the computer device via a network or communication link. For example, a data may be retrieved over a modem, over the internet, or over a local area network. Computer executable code embodied on a computer readable medium may be transmitted using any appropriate medium, including but not limited to wireless, wireline, optical fiber cable, RF, etc., or any suitable combination of the foregoing.

A computer readable signal medium may include a propagated data signal with computer executable code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

“Computer memory” or “memory” is an example of a computer-readable storage medium. Computer memory is any memory which is directly accessible to a processor. “Computer storage” or “storage” is a further example of a computer-readable storage medium. Computer storage is any non-volatile computer-readable storage medium. For example, computer storage may also be computer memory or vice versa.

A “processor” as used herein encompasses an electronic component which is able to execute a program or machine executable instruction or computer executable code. References to the computing device comprising “a processor” should be interpreted as possibly containing more than one processor or processing core. The processor may for instance be a multi-core processor. A processor may also refer to a collection of processors within a single computer device or distributed amongst multiple computer devices. The term computing device should also be interpreted to possibly refer to a collection or network of computing devices each comprising a processor or processors. The computer executable code may be executed by multiple processors that may be within the same computing device or which may even be distributed across multiple computing devices.

Computer executable code may comprise machine executable instructions or a program which causes a processor to perform an aspect of the present invention. Computer executable code for carrying out operations for aspects of the present invention may be written in any combination of one or more programming languages, including an object-oriented programming language such as Java, Smalltalk, C++ or the like and conventional procedural programming languages, such as the “C” programming language or similar programming languages and compiled into machine executable instructions. In some instances, the computer executable code may be in the form of a high-level language or in a pre-compiled form and be used in conjunction with an interpreter which generates the machine executable instructions on the fly.

The computer executable code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Generally, the program instructions can be executed on one processor or on several processors. In the case of multiple processors, they can be distributed over several different entities like clients, servers etc. Each processor could execute a portion of the instructions intended for that entity. Thus, when referring to a system or process involving multiple entities, the computer program or program instructions are understood to be adapted to be executed by a processor associated or related to the respective entity.

A “user interface” as used herein is an interface which allows a user or operator to interact with a computer or computer device. A ‘user interface’ may also be referred to as a ‘human interface device.’ A user interface may provide information or data to the operator and/or receive information or data from the operator. A user interface may enable input from an operator to be received by the computer and may provide output to the user from the computer. In other words, the user interface may allow an operator to control or manipulate a computer and the interface may allow the computer to indicate the effects of the operator's control or manipulation. The display of data or information on a display or a graphical user interface is an example of providing information to an operator. The receiving of data through a keyboard, mouse, trackball, touchpad, pointing stick, graphics tablet, joystick, gamepad, webcam, headset, gear sticks, steering wheel, pedals, wired glove, dance pad, remote control, one or more switches, one or more buttons, and accelerometer are all examples of user interface components which enable the receiving of information or data from an operator.

A GUI element is a data object some of which's attributes specify the shape, layout and/or behavior of an area displayed on a graphical user interface, e.g., a screen. A GUI element can be a standard GUI element such as a button, a text box, a tab, an icon, a text field, a pane, a check-box item or item group or the like. A GUI element can likewise be an image, an alphanumeric character or any combination thereof. At least some of the properties of the displayed GUI elements depend on the data value aggregated on the group of data object said GUI element represents.

Aspects of the present invention are described with reference to flowchart illustrations and/or block diagrams of methods, apparatus (systems) and computer program products. It will be understood that each block or a portion of the blocks of the flowchart, illustrations, and/or block diagrams, can be implemented by computer program instructions in form of computer executable code when applicable. It is further understood that, when not mutually exclusive, combinations of blocks in different flowcharts, illustrations, and/or block diagrams may be combined. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

Although the invention has been described in reference to specific embodiments, it should be understood that the invention is not limited to these examples only and that many variations of these embodiments may be readily envisioned by the skilled person after having read the present disclosure. The invention may thus further be described without limitation and by way of example only by the following embodiments. The following embodiments may contain preferred embodiments. Accordingly, the term “feature combination” as used therein may refer to such a “preferred embodiment”.

1. A computer-implemented method for correcting relative tooth positions of antagonistic teeth in occlusion for matching a natural occlusion,
the method comprising:
receiving a three-dimensional digital maxillary teeth model of a first set of one or more teeth of a maxilla of a patient, the teeth of the first set of teeth comprising first markings identifying one or more first surface contact sections of the teeth, the one or more first surface contact sections in natural occlusion being in contact with one or more second surface contact sections of one or more antagonistic teeth of a mandible of the patient,
receiving a three-dimensional digital mandibular teeth model of a second set of one or more teeth of the mandible of the patient, the teeth of the second set of teeth comprising one or more second markings identifying one or more of the second surface contact sections of the teeth,
identifying the first and second surface contact sections comprised by the teeth of the first and second set teeth using the first and second markings,
pairing the identified first and second surface contact sections, the pairing comprising determining pairs of first and second surface contact sections contacting each other in natural occlusion,
arranging the three-dimensional digital maxillary teeth model and the three-dimensional digital mandibular teeth model in occlusion,
correcting for one or more pairs of antagonistic teeth comprised by the first and second set of teeth relative tooth positions of the antagonistic teeth of the individual pairs, the correcting of the relative tooth positions comprising establishing contacts between the first surface contact sections and second surface contact sections of the pairs of first and second surface contact sections comprised by the antagonistic teeth of the individual pairs of antagonistic teeth.
   2. The method of feature combination 1, the correcting of the tooth positions comprising moving the antagonistic teeth in opposite directions along tooth axes of the respective teeth.
   3. The method of feature combination 2, the antagonistic teeth of one or more first pairs of the pairs of antagonistic teeth interpenetrating each other, the correcting of the tooth positions comprising moving the antagonistic teeth of the individual first pairs apart from each other along the tooth axes of the respective teeth, until one or more contacts between the one or more pairs of first and second surface contact sections comprised by the respective antagonistic teeth are established.
   4. The method of any of feature combinations 2 to 3, the antagonistic teeth of one or more second pairs of the pairs of antagonistic teeth comprising pairs of first and second surface contact sections arranged spaced apart from each other, the correcting of the tooth positions comprising moving the antagonistic teeth of the individual second pairs towards each other along the tooth axes of the respective teeth, until one or more contacts between the one or more pairs of first and second surface contact sections comprised by the respective antagonistic teeth are established.
   5. The method of any of feature combinations 2 to 4, the antagonistic teeth of the individual being moved by the same amount.
   6. The method of any of feature combinations 2 to 4, antagonistic teeth of the individual being moved by the different amounts.
   7. The method of feature combination 1, the correcting of the tooth positions comprising moving only teeth of one of the following: the first set of teeth, the second set of teeth.
   8. The method of feature combination 7, the correcting of the tooth positions comprising moving for the first pairs of antagonistic teeth the teeth to be moved along the tooth axes of the respective teeth away from the teeth not to be moved along the tooth axes of the respective teeth, until the one or more contacts between the one or more pairs of first and second surface contact sections of the respective antagonistic teeth are established.
   9. The method of any of feature combinations 7 to 8, the correcting of the tooth positions comprising moving for the second pairs of antagonistic teeth the teeth to be moved along the tooth axes of the respective teeth towards the teeth not to be moved along the tooth axes of the respective teeth, until the one or more contacts between the one or more pairs of first and second surface contact sections of the respective antagonistic teeth are established.
   10. The method of any of the preceding feature combinations, the correcting of the tooth positions further comprising moving teeth of the pairs of antagonistic teeth perpendicular to the tooth axes of the respective teeth.
   11. The method of any of the preceding feature combinations, the correcting of the tooth positions further comprising rotating teeth of the pairs of antagonistic teeth around one or more axes of rotation of the respective teeth.
   12. The method of feature combination 11, the one or more axes of rotation comprising one or more of the following axes per tooth extending perpendicular to each other: the tooth axis of the respective tooth, an axis extending in vestibula direction of the respective tooth, an axis extending in mesial direction of the respective tooth.
   13. The method of any of the preceding feature combinations, in case a number of pairs of first and second surface contact sections exceeds a number of interpenetrations between the teeth of the first and second sets of teeth in occlusion by a predefined first amount, outputting an error message and repeating one or more of the following: the identifying, the pairing.
   14. The method of any of the preceding feature combinations, further comprising:
acquiring first scan data of the first set of teeth of the maxilla of the patient using an intraoral scanner, the first sections of the teeth being marked with the first markings,
acquiring second scan data of the second set of teeth of the mandible of the patient using the intraoral scanner, the second sections of the teeth being marked with the second markings,
generating using the first scan data the three-dimensional digital maxillary teeth model comprising the first markings,
generating using the second scan data the three-dimensional digital mandibular teeth model comprising the second markings.
   15. The method of feature combination 14, in case the number of interpenetrations between the teeth of the first and second sets of teeth in occlusion exceeds the number of pairs of first and second surface contact sections determined by a predefined second amount, outputting an error message and repeating the acquiring of the first and second scan data as well as the generating of the three-dimensional digital maxillary teeth model and the three-dimensional digital mandibular teeth model.
   16. The method of any of feature combinations 14 to 15, further comprising segmenting the teeth of the three-dimensional digital maxillary teeth model and the three-dimensional digital mandibular teeth model.
   17. The method of any of feature combinations 14 to 16, further comprising acquiring occlusion scan data of the first set of teeth being in occlusion with the second set of teeth using the intraoral scanner, the occlusion scan data being used for the arranging of the three-dimensional digital maxillary teeth model and the three-dimensional digital mandibular teeth model in occlusion.
   18. The method of any of feature combinations 14 to 17, further comprising marking the first sections of the first set of teeth with the first markings for the acquiring of the first scan data and marking the second surface contact sections of the second set of teeth with the second markings for the acquiring of the first scan data using articulating paper, on which the patient bites.
   19. The method of feature combination 18, the first and second surface contact sections being marked using a visible marking color detectable by the intraoral scanner.
   20. The method of feature combination 18, the first and second surface contact sections being marked using an invisible marking color detectable by the intraoral scanner and represented using a visible color for the first markings in the three-dimensional digital maxillary teeth model and for the second markings in the mandibular teeth model.
   21. The method of any of the preceding feature combinations, the three-dimensional digital maxillary teeth model comprising a maxillary dental arch of the patient.
   22. The method of any of the preceding feature combinations, the three-dimensional digital mandibular teeth model comprising a mandibular dental arch of the patient.
   23. A computer program product for correcting relative tooth positions of antagonistic teeth in occlusion for matching a natural occlusion,
the computer program product comprising a computer readable storage medium having program instructions embodied therewith, the program instructions being executable by a processor of a computer device to cause the computer device to:
receive a three-dimensional digital maxillary teeth model of a first set of one or more teeth of a maxilla of a patient, the teeth of the first set of teeth comprising first markings identifying one or more first surface contact sections of the teeth, the one or more first surface contact sections in natural occlusion being in contact with one or more second surface contact sections of one or more antagonistic teeth of a mandible of the patient,
receive a three-dimensional digital mandibular teeth model of a second set of one or more teeth of the mandible of the patient, the teeth of the second set of teeth comprising one or more second markings identifying one or more of the second surface contact sections of the teeth,
identify the first and second surface contact sections comprised by the teeth of the first and second set teeth using the first and second markings,
pair the identified first and second surface contact sections, the pairing comprising determining pairs of first and second surface contact sections contacting each other in natural occlusion,
arrange the three-dimensional digital maxillary teeth model and the three-dimensional digital mandibular teeth model in occlusion,
   correct for one or more pairs of antagonistic teeth comprised by the first and second set of teeth relative tooth positions of the antagonistic teeth of the individual pairs, the correcting of the relative tooth positions comprising establishing contacts between the first surface contact sections and second surface contact sections of the pairs of first and second surface contact sections comprised by the antagonistic teeth of the individual pairs of antagonistic teeth.
   24. A computer program for correcting relative tooth positions of antagonistic teeth in occlusion for matching a natural occlusion,
the computer program comprising program instructions, the program instructions being executable by a processor of a computer device to cause the computer device to:
receive a three-dimensional digital maxillary teeth model of a first set of one or more teeth of a maxilla of a patient, the teeth of the first set of teeth comprising first markings identifying one or more first surface contact sections of the teeth, the one or more first surface contact sections in natural occlusion being in contact with one or more second surface contact sections of one or more antagonistic teeth of a mandible of the patient,
receive a three-dimensional digital mandibular teeth model of a second set of one or more teeth of the mandible of the patient, the teeth of the second set of teeth comprising one or more second markings identifying one or more of the second surface contact sections of the teeth,
identify the first and second surface contact sections comprised by the teeth of the first and second set teeth using the first and second markings,
pair the identified first and second surface contact sections, the pairing comprising determining pairs of first and second surface contact sections contacting each other in natural occlusion,
arrange the three-dimensional digital maxillary teeth model and the three-dimensional digital mandibular teeth model in occlusion,
   correct for one or more pairs of antagonistic teeth comprised by the first and second set of teeth relative tooth positions of the antagonistic teeth of the individual pairs, the correcting of the relative tooth positions comprising establishing contacts between the first surface contact sections and second surface contact sections of the pairs of first and second surface contact sections comprised by the antagonistic teeth of the individual pairs of antagonistic teeth.
   25. A computer device for correcting relative tooth positions of antagonistic teeth in occlusion for matching a natural occlusion,
the computer device comprising a processor and a memory storing program instructions executable by the processor, execution of the program instructions by the processor causing the computer device to:
receive a three-dimensional digital maxillary teeth model of a first set of one or more teeth of a maxilla of a patient, the teeth of the first set of teeth comprising first markings identifying one or more first surface contact sections of the teeth, the one or more first surface contact sections in natural occlusion being in contact with one or more second surface contact sections of one or more antagonistic teeth of a mandible of the patient,
receive a three-dimensional digital mandibular teeth model of a second set of one or more teeth of the mandible of the patient, the teeth of the second set of teeth comprising one or more second markings identifying one or more of the second surface contact sections of the teeth,
identify the first and second surface contact sections comprised by the teeth of the first and second set teeth using the first and second markings,
pair the identified first and second surface contact sections, the pairing comprising determining pairs of first and second surface contact sections contacting each other in natural occlusion,
arrange the three-dimensional digital maxillary teeth model and the three-dimensional digital mandibular teeth model in occlusion,
correct for one or more pairs of antagonistic teeth comprised by the first and second set of teeth relative tooth positions of the antagonistic teeth of the individual pairs, the correcting of the relative tooth positions comprising establishing contacts between the first surface contact sections and second surface contact sections of the pairs of first and second surface contact sections comprised by the antagonistic teeth of the individual pairs of antagonistic teeth.
   26. A system for correcting relative tooth positions of antagonistic teeth in occlusion for matching a natural occlusion, the system comprising the computer device of feature combination 24 and an intraoral scanner, execution of the program instructions by the processor further causing the computer device to:
control the intraoral scanner to acquire first scan data of the first set of teeth of the maxilla of the patient, the first sections of the teeth being marked with the first markings,
control the intraoral scanner to acquire second scan data of the second set of teeth of the mandible of the patient, the second sections of the teeth being marked with the second markings,
generating using the first scan data the three-dimensional digital maxillary teeth model comprising the first markings,
generating using the second scan data the three-dimensional digital mandibular teeth model comprising the second markings.

### REFERENCE SIGNS LIST

10 computer device
11 manufacturing system
14 external device
16 processing unit
18 bus
20 network adapter
22 I/O interface
24 display
28 memory
30 RAM
32 cache
34 storage system
40 program
42 program module
50 user interface
52 control elements
54 hardware device
56 keyboard
58 mouse
59 scanner
60 3D printing device
62 printing element
70 machining device
72 machining tool
74 holding device
76 blank
78 restoration material
100 3d digital mandibular teeth model
101 mandible
102 tooth
104 3D digital mandibular gingiva model
106 contact section
110 3D digital maxillary teeth model
112 tooth
114 3D digital maxillary gingiva model
116 contact section
120 articulating paper
122 interpenetration
124 direction of movement
130 pair of antagonistic teeth
140 3D digital restoration model
142 restoration element
150 tooth
152 gingiva
154 cementum
156 alveolar bone
158 periodontal ligament

1. A computer-implemented method for correcting relative tooth positions of antagonistic teeth in occlusion for matching a natural occlusion,
the method comprising:
receiving a three-dimensional digital maxillary teeth model of a first set of one or more teeth of a maxilla of a patient, the teeth of the first set of teeth comprising first markings identifying one or more first surface contact sections of the teeth, the one or more first surface contact sections in natural occlusion being in contact with one or more second surface contact sections of one or more antagonistic teeth of a mandible of the patient,
receiving a three-dimensional digital mandibular teeth model of a second set of one or more teeth of the mandible of the patient, the teeth of the second set of teeth comprising one or more second markings identifying one or more of the second surface contact sections of the teeth,
identifying the first and second surface contact sections comprised by the teeth of the first and second set teeth using the first and second markings,
pairing the identified first and second surface contact sections, the pairing comprising determining pairs of first and second surface contact sections contacting each other in natural occlusion,
arranging the three-dimensional digital maxillary teeth model and the three-dimensional digital mandibular teeth model in occlusion,
correcting for one or more pairs of antagonistic teeth comprised by the first and second set of teeth relative tooth positions of the antagonistic teeth of the individual pairs, the correcting of the relative tooth positions comprising establishing contacts between the first surface contact sections and second surface contact sections of the pairs of first and second surface contact sections comprised by the antagonistic teeth of the individual pairs of antagonistic teeth.

2. The method of claim 1, the correcting of the tooth positions comprising moving the antagonistic teeth in opposite directions along tooth axes of the respective teeth.

3. The method of claim 2, the antagonistic teeth of one or more first pairs of the pairs of antagonistic teeth interpenetrating each other, the correcting of the tooth positions comprising moving the antagonistic teeth of the individual first pairs apart from each other along the tooth axes of the respective teeth, until one or more contacts between the one or more pairs of first and second surface contact sections comprised by the respective antagonistic teeth are established.

4. The method of claim 2, the antagonistic teeth of one or more second pairs of the pairs of antagonistic teeth comprising pairs of first and second surface contact sections arranged spaced apart from each other, the correcting of the tooth positions comprising moving the antagonistic teeth of the individual second pairs towards each other along the tooth axes of the respective teeth, until one or more contacts between the one or more pairs of first and second surface contact sections comprised by the respective antagonistic teeth are established.

5. The method of claim 1, the correcting of the tooth positions comprising moving only teeth of one of the following: the first set of teeth, the second set of teeth.

6. The method of claim 5, the correcting of the tooth positions comprising moving for the first pairs of antagonistic teeth the teeth to be moved along the tooth axes of the respective teeth away from the teeth not to be moved along the tooth axes of the respective teeth, until the one or more contacts between the one or more pairs of first and second surface contact sections of the respective antagonistic teeth are established.

7. The method of claim 5, the correcting of the tooth positions comprising moving for the second pairs of antagonistic teeth the teeth to be moved along the tooth axes of the respective teeth towards the teeth not to be moved along the tooth axes of the respective teeth, until the one or more contacts between the one or more pairs of first and second surface contact sections of the respective antagonistic teeth are established.

8. The method of claim 1, the correcting of the tooth positions further comprising moving teeth of the pairs of antagonistic teeth perpendicular to the tooth axes of the respective teeth.

9. The method of claim 1, the correcting of the tooth positions further comprising rotating teeth of the pairs of antagonistic teeth around one or more axes of rotation of the respective teeth.

10. The method of claim 9, the one or more axes of rotation comprising one or more of the following axes per tooth extending perpendicular to each other: the tooth axis of the respective tooth, an axis extending in vestibula direction of the respective tooth, an axis extending in mesial direction of the respective tooth.

11. The method of claim 1, in case a number of pairs of first and second surface contact sections exceeds a number of interpenetrations between the teeth of the first and second sets of teeth in occlusion by a predefined first amount, outputting an error message and repeating one or more of the following: the identifying, the pairing.

12. The method of claim 1, further comprising:
acquiring first scan data of the first set of teeth of the maxilla of the patient using an intraoral scanner, the first sections of the teeth being marked with the first markings,
acquiring second scan data of the second set of teeth of the mandible of the patient using the intraoral scanner, the second sections of the teeth being marked with the second markings,
generating using the first scan data the three-dimensional digital maxillary teeth model comprising the first markings,
generating using the second scan data the three-dimensional digital mandibular teeth model comprising the second markings.

13. The method of claim 12, in case the number of interpenetrations between the teeth of the first and second sets of teeth in occlusion exceeds the number of pairs of first and second surface contact sections determined by a predefined second amount, outputting an error message and repeating the acquiring of the first and second scan data as well as the generating of the three-dimensional digital maxillary teeth model and the three-dimensional digital mandibular teeth model.

14. The method of claim 12, further comprising acquiring occlusion scan data of the first set of teeth being in occlusion with the second set of teeth using the intraoral scanner, the occlusion scan data being used for the arranging of the three-dimensional digital maxillary teeth model and the three-dimensional digital mandibular teeth model in occlusion.

15. The method of claim 12, further comprising marking the first sections of the first set of teeth with the first markings for the acquiring of the first scan data and marking the second surface contact sections of the second set of teeth with the second markings for the acquiring of the first scan data using articulating paper, on which the patient bites.

16. The method of claim 15, the first and second surface contact sections being marked using a visible marking color detectable by the intraoral scanner.

17. The method of claim 15, the first and second surface contact sections being marked using an invisible marking color detectable by the intraoral scanner and represented using a visible color for the first markings in the three-dimensional digital maxillary teeth model and for the second markings in the mandibular teeth model.

18. A computer program product for correcting relative tooth positions of antagonistic teeth in occlusion for matching a natural occlusion,
the computer program product comprising a computer readable storage medium having program instructions embodied therewith, the program instructions being executable by a processor of a computer device to cause the computer device to:
receive a three-dimensional digital maxillary teeth model of a first set of one or more teeth of a maxilla of a patient, the teeth of the first set of teeth comprising first markings identifying one or more first surface contact sections of the teeth, the one or more first surface contact sections in natural occlusion being in contact with one or more second surface contact sections of one or more antagonistic teeth of a mandible of the patient,
receive a three-dimensional digital mandibular teeth model of a second set of one or more teeth of the mandible of the patient, the teeth of the second set of teeth comprising one or more second markings identifying one or more of the second surface contact sections of the teeth,
identify the first and second surface contact sections comprised by the teeth of the first and second set teeth using the first and second markings,
pair the identified first and second surface contact sections, the pairing comprising determining pairs of first and second surface contact sections contacting each other in natural occlusion,
arrange the three-dimensional digital maxillary teeth model and the three-dimensional digital mandibular teeth model in occlusion,
correct for one or more pairs of antagonistic teeth comprised by the first and second set of teeth relative tooth positions of the antagonistic teeth of the individual pairs, the correcting of the relative tooth positions comprising establishing contacts between the first surface contact sections and second surface contact sections of the pairs of first and second surface contact sections comprised by the antagonistic teeth of the individual pairs of antagonistic teeth.

19. A system for correcting relative tooth positions of antagonistic teeth in occlusion for matching a natural occlusion comprising a computer device,
the computer device comprising a processor and a memory storing program instructions executable by the processor, execution of the program instructions by the processor causing the computer device to:
receive a three-dimensional digital maxillary teeth model of a first set of one or more teeth of a maxilla of a patient, the teeth of the first set of teeth comprising first markings identifying one or more first surface contact sections of the teeth, the one or more first surface contact sections in natural occlusion being in contact with one or more second surface contact sections of one or more antagonistic teeth of a mandible of the patient,
receive a three-dimensional digital mandibular teeth model of a second set of one or more teeth of the mandible of the patient, the teeth of the second set of teeth comprising one or more second markings identifying one or more of the second surface contact sections of the teeth,
identify the first and second surface contact sections comprised by the teeth of the first and second set teeth using the first and second markings,
pair the identified first and second surface contact sections, the pairing comprising determining pairs of first and second surface contact sections contacting each other in natural occlusion,
arrange the three-dimensional digital maxillary teeth model and the three-dimensional digital mandibular teeth model in occlusion,
correct for one or more pairs of antagonistic teeth comprised by the first and second set of teeth relative tooth positions of the antagonistic teeth of the individual pairs, the correcting of the relative tooth positions comprising establishing contacts between the first surface contact sections and second surface contact sections of the pairs of first and second surface contact sections comprised by the antagonistic teeth of the individual pairs of antagonistic teeth.

20. The system of claim 19, further comprising an intraoral scanner, execution of the program instructions by the processor further causing the computer device to:
control the intraoral scanner to acquire first scan data of the first set of teeth of the maxilla of the patient, the first sections of the teeth being marked with the first markings,
control the intraoral scanner to acquire second scan data of the second set of teeth of the mandible of the patient, the second sections of the teeth being marked with the second markings,
generating using the first scan data the three-dimensional digital maxillary teeth model comprising the first markings,
generating using the second scan data the three-dimensional digital mandibular teeth model comprising the second markings.
